(19) United States
(12) Patent Application Publication
(10) Pub. No.: US 2010/0302163 A1
(43) Pub. Date: Dec. 2, 2010

(54) DATA ENTRY SYSTEM

(76) Inventor: Benjamin Firooz Ghassabian, Jerusalem (IL)

Correspondence Address: BROWDY AND NEIMARK, P.L.L.C.;624 NINTH STREET, NW, SUITE 300, WASHINGTON, DC, 20001-5303, US

(21) Appl. No.: 12/675,956

(22) PCT Filed: Sep. 1, 2008
(86) PCT No.: PCT/IB08/02263

§ 371 Date: Mar. 1, 2010

Related U.S. Application Data
(63) Continuation-in-part of application No. 61/005,567, filed on Dec. 5, 2007.
(60) Provisional application No. 60/967,285, filed on Aug. 31, 2007.
(60) Provisional application No. 60/935,990, filed on Sep. 7, 2007.
(60) Provisional application No. 60/993,205, filed on Sep. 10, 2007.
(60) Provisional application No. 60/998,912, filed on Oct. 12, 2007.
(60) Provisional application No. 60/999,214, filed on Oct. 16, 2007.

(30) Foreign Application Priority Data
Jan. 1, 2008 (IL) 188523

(51) Int. Cl. G06F 3/02

(52) U.S. Cl. 345/168

(57) ABSTRACT

A computerized device comprising a first input interface adapted to identify a plurality of different first user input signals; a second input interface adapted to identify a plurality of second user input signals, and a processor configured to ambiguously correspond to each of at least one of the first input signals with the first plurality of symbols, and to ambiguously correspond actuation of each of at least one of the second input signals with a second plurality of symbols. The processor associates each of the second plurality of symbols with one of the first input signals in a manner that the second plurality of symbols corresponds to a plurality of first input signals.

### RELATED APPLICATIONS

The present application claims the benefit, under 35 USC 119(e), of U.S. provisional application U.S. Ser. No. 60/967,285 filed Aug. 31, 2007; of U.S. Ser. No. 60/935,990 filed Sep. 7, 2007; of U.S. Ser. No. 60/993,205 filed Sep. 10, 2007; of U.S. Ser. No. 60/998,912 filed Oct. 12, 2007; of U.S. Ser. No. 60/999,214 filed Oct. 16, 2007 and of U.S. Ser. No. 61/005,567 filed Dec. 5, 2007, all to Firooz Ghassabian. The disclosures of all of the above are incorporated herein by reference in their entireties.

This application is also related to various prior PCT publications, including WO01/131788, titled “Integrated Keypad System”; WO03/007288 titled “Features to Enhance Data Entry Through a Small Data Entry Unit”; WO04/095414 titled “System to Enhance Data Entry in Mobile and fixed Environment”; WO05/122401 titled “System to Enhance Data Entry in Mobile and fixed Environment”; WO07/114833 titled “Data Entry System”, and PCT application IB2007/004481; the disclosures of all of which are also incorporated herein, by reference, in their entireties.

### FIELD OF THE INVENTION

The present invention relates to data input devices and particularly to keyboards having limited numbers of keys and to mobile phone keypads and the like.

### BACKGROUND OF THE INVENTION

The use of computerized devices, such as general purpose computers, cellular phones and personal digital assistants (PDA), requires convenient data input. While the QWERTY keyboard is widely used for general purpose computers, such as desktop PCs, portable computers, terminals of mainframes and the like, the full QWERTY keyboard is generally considered too large for portable devices. By way of example, cellular phones generally have a 12 key keypad primarily designed for dialing numbers. For data entry into the internal phone directory, and increasingly for SMS and similar purposes, in addition to being assigned a digit, each key is also assigned a plurality of letters of the alphabet. In order to indicate a specific letter out of the range of letters assigned to a key, according to a first known method, the user is required to press the key a number of times to toggle between the different numbers and letters supported thereby. This requirement makes textual entry via what is primarily a number-pad, both slow and unwieldy. According to a second known method, it has been suggested that the computerized device receiving input from keys assigned a plurality of letters, henceforth ambiguous keys, attempts to guess the word intended by the user, typically by context, dictionary database listings, previous history and the like. However, in cases where the computerized device guesses incorrectly, the user is required to refer to a different input method in a relatively slow process. Thus even if the computerized device guesses over 90% of the words entered, the input is slowed down significantly because remaining words require being separately manually inputted.

U.S. Pat. No. 6,734,881 to Will, titled “Efficient Entry of Words by Disambiguation”, suggests prompting the user with a list of letters or words from which the user selects the correct entry.

PCT Publication No. WO05/122401, titled “System to Enhance Data Entry in Mobile and fixed Environment”, to the present inventor, suggests using speech identification to receive complimentary information to the user's key strokes, thus allowing faster correction of incorrect word guesses. Whilst the combination of fuzzy logic and speech reception and identification apparatus offers an attractive solution, speech identification is not available on many such devices, and since it requires a lot of memory and processing power, the general approach may be inherently unsuitable for portable devices that are powered by batteries. Usage in noisy environments may also be problematic.

PCT Publication No. WO07/114833, titled “Data Entry System”, suggests providing an additional keyboard in which each key corresponds to a single letter for disambiguation. This approach requires providing a keyboard having a relatively large number of keys, and is thus not desirable on small devices where space is a premium.

Alternatively, a keyboard offering a smaller set of keys with a multi-tap scheme in which the user indicates the intended letters by using different numbers of taps on the same key may be used for disambiguation. Use of a multi-tap scheme, however, is slow and inconvenient to many users.

### SUMMARY OF THE INVENTION

The data entry system of the invention uses a first set of symbols including at least substantially all of the letters of the alphabet of at least one language, wherein said letters are assigned in a distributive manner to at least some (e.g. four) of the keys of a first set of keys (e.g. first keypad) such that at least two of the letters are assigned to at least one of said keys of the first set of keys (e.g. ambiguous keys of the first keypad).

The system also includes a second set of keys (e.g. a second keypad) such as for example a telephone-type (i.e. primarily numeric) keypad wherein an additional set of symbols including at least substantially all of the letters of the alphabet of the at least one language, wherein said letters are assigned in a distributive manner to at least some of the keys of the second set of keys such that at least two of the letters are assigned to at least one of the keys of the second set of keys (e.g. ambiguous keys of the second keypad). An (e.g. a predefined) interaction, such as a pressing action on an ambiguous key of either of said keypads, may, ambiguously, correspond to any character of the group of symbols/letters assigned to that key.

According to one embodiment of the invention, the letters on said few (e.g. four ambiguous) keys of said first keypad and the letters on said second (e.g. telephone-type) keypad may be distributed such that a (e.g. any) key of said letter keys of said first keypad and a (e.g. any) key of said letter keys of said second keypad may have at most one (ambiguous) common letter/character.

In order to enter a precise character/letter of an ambiguous key, according to the preferred embodiment of the invention, by way of example, the user may first press the key of the first keypad corresponding to said character/letter and then press the key of the second keypad also corresponding to said desired character/letter, or vise-versus. By considering said key presses and the fact that there is at most one character common to the two keys, the system precisely selects/enters the desired character/letter.

By using key-presses of two keys, the data entry system of the invention thus provides precise character identification, with the unique, character common to the two keys being unambiguously selected thereby. Although having utility on its own, the system as described hereinabove may usefully be used together with other techniques directed at easy text entry with multi-letter keys, such as a software based word predictive system wherein ambiguous key selections are compared with words within a database, including words and corresponding key press information as known, to predict or confirm the user's intention. The principles of such word predictive systems are known to those skilled in the art. In this manner, a fast and highly accurate data/text entry system using a reduced keyboard and a few keys, each having a plurality of characters ascribed thereto, may be provided.

For example, in order to enter a desired word, according to one method the user may first provide a first input information by pressing the ambiguous keys of the first keypad corresponding to the characters of the desired word. The system may propose a word from the database corresponding to the first input information. For example, in accordance with one method, the word suggested is the word having the highest priority among the words corresponding to the input information. If the proposed word is not the desired word, the user may proceed with what is referred to herein as a correction procedure; providing additional input information by pressing a key of the second keypad corresponding to one of the characters, typically the first character of the desired word. By relating the key presses of the first and the second keypad corresponding to the character, and the fact that there is at most one character common to both selected keys, the character is precisely and unambiguously selected, and the system precisely recognizes the character. By considering the combined input information, the system proposes another word from the database, corresponding to the combined information. If the new word proposed by the system is not the desired word, the user may provide additional input information, e.g. by pressing the key of the second keypad corresponding to the next/more character(s) of the desired word, until the system chooses the desired word.

According to another method, the user may first provide precisely at least one character of the desired word by entering a precise character as described above and by pressing ambiguous keys of the first keypad that (non-uniquely) correspond to the remaining characters of the desired word. By precisely recognizing at least one character of the word and by also considering the ambiguous key presses corresponding to the remaining characters of the word, the system is able to more accurately predict the desired word and proposes it to the user. If the proposed word is not the desired word, the user may provide additional pressing actions on the keys of the second keypad corresponding to the additional characters of the desired word until the system predicts/proposes the desired word.

If the desired word is not in the dictionary, then, in addition to the first input information provided through the first keypad, generally, the user presses the keys of the second keypad corresponding to all of the letters of the desired word.

The data entry system and correction thereof as described hereinabove is a very easy system to use, enabling fast data entry. Briefly stated, the user types the desired word using the first keypad. Generally, the system proposes the right (e.g. desired) word. If a non-desired word or no word is proposed, the user begins to retype the word using the second keypad. If the word is in the dictionary database, most of the time, the system proposes the word as soon as retyping the word using the second keypad commences. If the word is not in the dictionary, the user retypes all of the letters of the word. With such a system of word predictive data/text entry, the user need not be concerned as to whether the word is or is not found in the database (dictionary) since he knows that at some point, either during typing on the first keypad or when retyping using the second keypad, the system will propose the desired word, offering an automatic word completion.

An aspect of some embodiments of the present invention relates to using a second reduced set of keys in which at least some user input actions are associated ambiguously with a plurality of letters, for resolving ambiguities in data entered through a first set of keys associated ambiguously with a plurality of letters. The letters associated with the keys of the first set of keys are optionally arranged such that no key of the first set has more than one letter ascribed thereto that is common with a key of the second set. Accordingly, actuation of two keys, one selected from the first set, and a second key selected from the second set results in an unambiguous selection of a specific letter.

By way of example, in order to enter a precise character/letter, the user may first press the corresponding key of the first keypad and then press the corresponding key of the second keypad. It will be appreciated that the order can also be reversed. By considering the key presses and the fact that there is at most one character (e.g. the desired character/letter) common to both keys, the system precisely enters the (desired) character/letter. As stated hereinabove, this method of entry of a precise character/letter may be used with or without other data entry methods, such as speech recognition and word prediction.

Preferably, the number of symbols supported includes substantially all of the elementary symbols, including the digits from 0 to 9, a full alphabet, preferably at least the commonest punctuation marks, if not the full set thereof, and perhaps function keys or commands for inputting or editing text and/or for interacting with the computer.

The first and second sets of keys may support the Latin alphabet and/or any other alphabet of interest, such as Hebrew, Arabic, Korean, etc., or at least portions thereof. Furthermore, the first and second sets of keys may cover additional symbols, such as digits, punctuation marks and/or other symbols conventionally appearing on keyboards. Alternatively, some symbols which are less frequently used may be provided using unambiguous key strokes, such as using the keys of the first set or of the second set with a state selection key (e.g., a shift button). In one embodiment of the invention one or more of the keys of the first or second set may additionally serve as state selection keys, such as when depressed for longer than a predetermined duration, for example.

In accordance with an exemplary embodiment of the invention, there is therefore provided: a computerized device, comprising (i) a first input interface adapted to identify a plurality of different first user input signals, (ii) a second input interface adapted to identify a plurality of second user input signals and (iii) a processor configured to ambiguously correspond each of at least one of the first input signals with a first plurality of symbols, and to ambiguously correspond actuation of each of at least one of the second input signals with a second plurality of symbols. The processor associates each of the second plurality of symbols with one of the first input signals, in such a manner that the second plurality of symbols corresponds to a plurality of the first input signals.

Optionally, the processor corresponds each of the second input signals with a plurality of symbols. Optionally, the processor corresponds each of the first input signals with a plurality of symbols. Optionally, the processor corresponds the first input signals with symbols, such that together, the first input signals are associated with all the letters of an alphabet of a natural language.

Optionally, the processor corresponds the second input signals with symbols, such that together, the second input signals are associated with all the letters of the supported alphabet. Optionally, the processor corresponds each letter of the alphabet with a single first input signal. Optionally, the processor corresponds each letter of the alphabet with a single second input signal. Optionally, the processor is configured to guess a word intended by a user based on a sequence of first input signals. Preferably, the processor is configured to update its word guess, responsive to one or more of the second input signals.

Optionally, the device includes a memory for storing a dictionary of words therewithin, and the processor is configured to use the dictionary in guessing the intended word. Optionally, the dictionary includes indications of popularities of words in the dictionary and the processor is configured to use the popularity indications when guessing and suggesting the intended word. Optionally, one of the first input signals and one of the second input signals are implemented by actuation of a same (i.e. common or mutual) physical key, at different processor operation states. Optionally, in at least some embodiments, the processor is configured to apply a second input signal to a different position within the currently proposed word, than a first input signal from a same cursor location.

Optionally, the processor is configured to apply a second input signal to a different current word position than a first input signal, from a same cursor location, when the second input signal is interpreted to relate to symbols also corresponding to first input signals. Optionally, the processor is configured to relate a second input signal to a first position of a current word, which was not related to by a second key in a current handling of the word.

Optionally, the processor is configured to relate a second input signal to a character immediately before a current cursor position managed by the processor. Optionally, the processor is configured to associate a second input signal with a character not corresponding to any of the first input signals, when the second input signal is provided not during insertion of a word using the first input signal. Optionally, the first and second input interfaces are implemented by a single hardware unit.

Optionally, the first input interface comprises a physical keypad and/or a touch screen. Optionally, the second input interface comprises a virtual keypad. Optionally, the first input interface comprises a plurality of first keys; the second input interface comprises a plurality of second keys, and the processor is configured to relate to at least one of the first keys as being a state selection key for one or more of the second keys if and when the first key is interacted with in a different manner, such as if depressed for longer than a predetermined duration, for example. Optionally, the processor is configured to display the corresponding symbols of the second keys in the selected state, when the first key is interacted with in a different manner, such as if depressed for longer than a predetermined duration.

Optionally, first input interface comprises a plurality of first keys not having their corresponding symbols displayed thereupon. Optionally, the second input interface comprises a plurality of keys having their corresponding symbols presented thereupon. Optionally, the processor is configured to display the corresponding symbols of the first set of keys on a screen, selectively, such as when input using the first keys is expected. Optionally, the processor is configured to associate the first and second input signals with symbols in a manner such that each pair of first and second input signals has no more than one symbol in common.

The word key as used herein, typically refers to standard interfaces having push-button keys. However, this is by way of none-limiting example only, and it will be understood that interfaces compatible with the invention include other user input devices, such as touch sensitive keypads, touch pads, other types of tactile interfaces, and the like.

Optionally, the processor is configured to associate the input signals with symbols in such a manner that each pair of first and second input signals has a symbol in common. Optionally, the first input interface supports no more than six to eight different input signals, which are used for inserting symbols. Optionally, the second interface supports no more than twelve different input signals.

Preferably, the first input interface supports no more than four different input signals, which are used for inserting symbols. Optionally, the second interface supports no more than ten different input signals.

There is further provided in accordance with an exemplary embodiment of the invention, a method of assigning letters to keys of a keypad, comprising providing a dictionary that lists words and corresponding popularities of usage of the words, providing a keypad including fewer keys than letters of the alphabet, assigning the letters of the alphabet to actuation acts of the keys of the keyboard, such that one or more key actuation acts is ambiguously associated with a plurality of letters.

The assigning is performed in a manner which attempts to increase the probability that a sequence of key actuations via the first keypad that correspond to a specific word found in the dictionary will be associated with that word by a processor selecting words from the dictionary.

Optionally, the assigning of the letters of the alphabet to actuation acts of the keys comprises assigning in a manner which assigns letters having similar sounds to different keys.

There is further provided in accordance with an exemplary embodiment of the invention, a computerized device, comprising a plurality of data input keys, and a processor configured to relate to at least one of the keys as representing one or more symbols if actuated in a first manner and to relate to the at least one of the keys as a state selection key if actuated in a second manner.

To maximize usage of a minimum number of keys, it is preferable that at least some keys can be used both as function keys and as input keys for inputting symbols such as letters and numbers, etc. Thus optionally, the processor is configured to relate to at least one of the keys as representing one or more symbols if actuated for a period shorter than a predetermined amount of time and to relate to the at least one of the keys as a state selection key if actuated for longer than a predetermined time. Other ways of providing different inputs via the same key may be supported, such as by double clicking, or by depressing the key whilst simultaneously depressing a shift key of space key, for example.

There is further provided, in accordance with an exemplary embodiment of the invention, a method of managing an input reception device of the type including a plurality of keys and a screen. The method comprises receiving user input through the keys; determining a state of the input responsive to the previously actuated keys; and displaying a symbol assignment of at least some of the keys on the screen if the device is determined to be in a first state, but not displaying the symbol assignment if the device is determined to be in a second state.

Optionally, displaying the symbol assignment comprises displaying in a manner which moves with a cursor of the screen.

There is further provided in accordance with an exemplary embodiment of the invention, a device for receiving input signals, comprising a first input interface including a plurality of keys, which are together associated with the letters of a specific alphabet, a second input interface adapted to identify a plurality of second user input signals, which are associated with the letters of the specific alphabet, and a processor configured to interpret actuation of the keys of the first input interface as corresponding respectively to groups of one or more letters of the specific alphabet and to interpret the plurality of second user input signals as corresponding respectively to groups of one or more letters of the specific alphabet. The second input interface may be located between the keys, i.e. within the extremities of the keypad of the first input interface.

For example, one keypad could comprise keys arranged along the edge of a display screen and the other keypad could be a touch screen pad within that display screen.

Optionally, the second input interface comprises a plurality of physical keys.

Alternatively, the second input interface comprises a plurality of virtual on-screen keys.

Optionally, the first input interface comprises at most six keys. Optionally, the distance from one of the first keys to the second input interface is greater than the radius of the second input interface.

For clarity, generally the term keypad is used for small collections of keys, reserving the term keyboard for QWERTY and similar arrangements with large arrays of keys. This convention has not been strictly adhered to however, and both terms are used interchangeably and synonymously. Similarly, the terms buttons and keys are used interchangeably to refer to real or virtual (touch screen) areas that are selectable by the user for data-entry purposes.

### BRIEF DESCRIPTION OF THE DRAWINGS

The present invention will now be described in the following detailed description of exemplary embodiments with reference to the attached figures. Generally, only structures, elements or parts that are germane to the discussion are shown in the figures.

FIG. 1 shows an example of a data entry system in accordance with one embodiment of the present invention;

FIG. 2 shows an example of a data entry system in accordance with another embodiment of the present invention;

FIG. 3 illustrates a key arrangement, in accordance with another embodiment of the present invention;

FIG. 3A illustrates a key arrangement, in accordance with still another embodiment of the present invention;

FIG. 4 is a schematic illustration of a data entry device, in accordance with an exemplary embodiment of the invention;

FIG. 4A is a schematic illustration of a data entry device, in accordance with another exemplary embodiment of the invention;

FIG. 5 is a schematic illustration of a data entry device, in accordance with still another exemplary embodiment of the invention;

FIG. 6 is a schematic illustration of a data entry system, in accordance with an exemplary embodiment of the invention;

FIG. 6A is a schematic illustration of a data entry system, in accordance with another exemplary embodiment of the invention;

FIG. 7 is a schematic illustration of a data entry device, in accordance with another exemplary embodiment of the invention;

FIG. 8 illustrates a key arrangement, in accordance with another embodiment of the present invention;

FIG. 8A illustrates two optional divisions of keys between two key sets, in accordance with another embodiment of the present invention;

FIG. 9 is a schematic illustration of a device including a data entry system, in accordance with another exemplary embodiment of the invention;

FIG. 10 is a schematic illustration of a data entry device, in accordance with another exemplary embodiment of the invention;

FIG. 11 illustrates a key arrangement, in accordance with another embodiment of the present invention;

FIG. 12 is a schematic illustration of a data entry system, in accordance with an exemplary embodiment of the invention, and

FIG. 13 is a flowchart of acts of a data entry system, in accordance with an exemplary embodiment of the invention.

### DETAILED DESCRIPTION OF EMBODIMENTS OF THE INVENTION

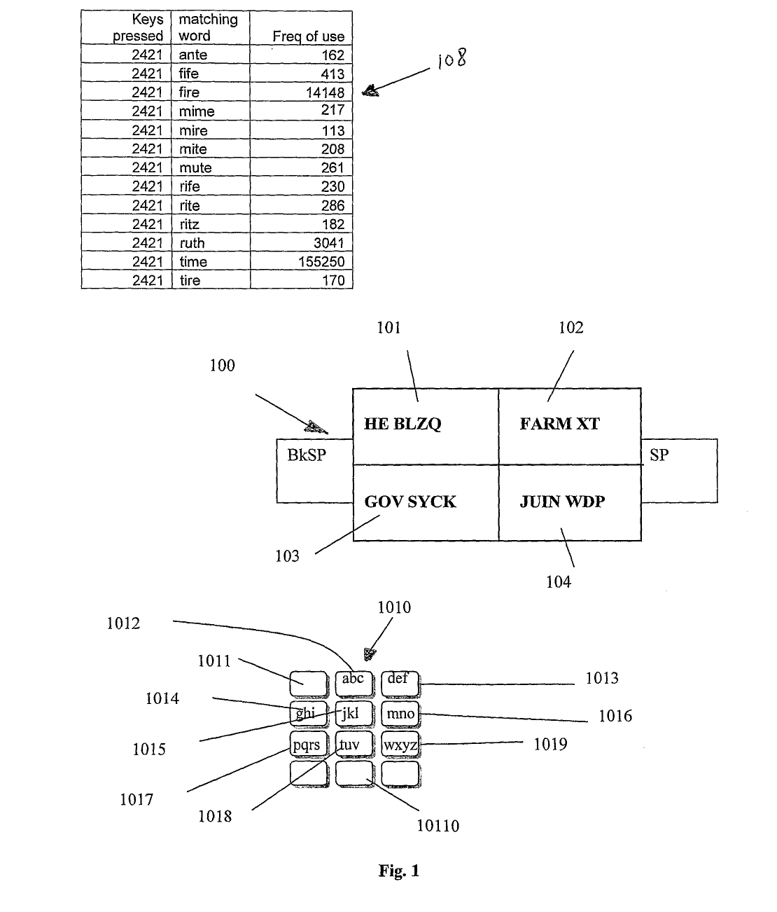

FIG. 1 shows an example of a first keypad 100 of a combined (e.g. predictive) data entry system in accordance with one embodiment of the present invention wherein the letters of the English language are assigned to four of the keys 101-104 thereof. A second keypad, typically an additional set of keys of the system 1010 is also shown, which, in this specific example, is a 3×4 key array, somewhat resembling a telephone-type keypad having the letters of the English language distributed on eight of its keys (1012-1019), in a standard manner. The first and second keypads may be used to input (type) text in a fast manner by the user, without requiring multi-tap schemes or special key actuations. Without loss of generality, the user enters desired text using keys 101, 102, 103, 104, and, when necessary, the backspace button BKSP shown on the left. For each desired letter, the user presses the four-letter key that corresponds to that letter, without worrying about which letter from the plurality of letters supported thereby, is selected. In some embodiments, use of the space button SP shown on the right, is supported. A processor of the system that is associated with the interface, i.e. associated with the first and second key pads, guesses the intended word using a dictionary database and a simple selection process, typically frequency of use, previous usage, etc. As long as the processor correctly suggests the intended words, the second keyboard is not used for amending the word string entered. When, however, the processor guesses the wrong word, for example because the word used is not in the dictionary database at all, or has a low frequency of use, the user uses the second keypad in order to actively and precisely select one or more desired letter, thereby correcting the input. In order to perform such a correction, the user optionally places the cursor on the word, typically at the end thereof, but optionally in the middle of the word to be corrected. It will be noted that if the wrong guess is identified while typing the current word there is no need to move the cursor.

The user then presses a key from the second set of keys (keypad), corresponding to the correction letter of one of the positions of the word. In an exemplary embodiment of the invention, correction key actuations of the second keypad always correspond to the first position of the word that was not yet corrected. Although the second key may correspond to several different letters and the user does not need to indicate which of the corresponding letters is intended, the processor, by using for the corrected position only the letters covered by both the first and second keys actuated for the specific position, will be able to limit the possible words so that the chances of guessing correctly will be much higher. In some embodiments of the invention, each pair of first and second keys has only one common letter, such that in these embodiments the specific corrected position has a definite letter. If necessary or desired, the user may use the second keyboard to input several letters of the word or even the entire word. In many cases, however, correction of a single position in the word using a second key will be sufficient to allow the processor to guess the intended word and the user can immediately proceed with pressing the space bar of the first key set and moving to the next word.

For example, in order to enter the letter “t”, the user may first press the corresponding key 102 from the first keypad 100 which supports the letter “t” (and a number of other letters, including the more frequent “a”). The system may propose the letter “a” since this has the highest frequency of usage of the letters supported by key 102, and thus the highest probability of being the desired selection. The user can, however, press the key 1018 of the second keypad 1010 corresponding to the desired letter “t”. Key 1018 from second keypad 1010 is also an ambiguous key however, since it corresponds to and supports three letters, i.e. to “t”, “u”, and “v”. By considering the letters supported by the first key 102, i.e. “f”, “a”, “r”, “m”, “x”, “t” with the letters supported by the second pressed key 1018 (“t”, “u”, and “v”), the system recognizes that the only letter that is common to both keys 102, 1018, is the letter “t”, and the system proposes/enters this letter.

The above-mentioned system for entering a precise character may be used by data entry/correction systems of the invention with or without word predictive facility, to replace and/or duplicate other methods of entry of a precise character and the corresponding word level data/text entry and correction systems as described in any of the following PCT publications: WO01/131788, titled “Integrated Keypad System”; WO03/007288 titled “Features to Enhance Data Entry Through a Small Data Entry Unit”; WO04/095414 titled “System to Enhance Data Entry in Mobile and fixed Environment”; WO05/122401 titled “System to Enhance Data Entry in Mobile and fixed Environment”; WO07/114833 titled “Data Entry System”, and PCT application IB2007/004481—all filed by the present inventor, the disclosures of all being incorporated herein by reference in their entireties.

By way of example, FIG. 1 shows a selection (or portion) 108 from a database of words in accordance with an embodiment of the invention. According to one method of data entry: considering the keypads 100 and 1010, in order to enter the word “fire”, if the user presses the corresponding keys, 102, 104, 102, 101, of the first keypad 100 (e.g. the first input information), the system may propose the word “time”, since this word has the highest priority from among the words in the dictionary database corresponding to the first input information. However, in this instance, this is not the word desired by the user. According to one method, the user may first precisely enter at least one of the characters/letters (e.g. in this example the letter “f”) of the word through the character entry system just described, by pressing the corresponding key 102, corresponding inter alia, to the letter “f” of the first keypad 100 and pressing the key 1013 corresponding, inter alia, to the letter “f” of the second keypad 1010, and then pressing the keys 104, 102, 101, of the first keypad 100, that correspond (non-uniquely) to the remaining characters of said word. Letter “f” is the only letter common to keys 102 and 103; therefore the system provides/proposes it precisely. By considering the precise (first) letter of the desired word, and the ambiguous key presses corresponding to the remaining characters of said word (e.g. the combined input information), the system proposes the word “fire” as having the highest priority among the words of the dictionary that correspond to said input information. This combination of precisely selected letters and probable words including such precisely selected letters thus provides an easy, quick and precise method of selecting desired words.

The above method of providing information which leads to a specific character being precisely selected, may also be used for correction purposes by correction procedures of the system. According of one method of data entry, considering the keypads 100, 1010: in order to enter the word “fire”, the user may press the corresponding keys, 102, 104, 102, 101, of the keypad 100 to enter an ambiguous data string, also known herein, as the first input information. The system may propose the word “time” since this has the highest priority among the words of the dictionary corresponding to the first input information. The user may proceed to the correction procedure of the invention by providing additional information that helps the system to recognize at least one, e.g. first character of the desired word.

According to one embodiment, if the proposed word is not the desired word, the user presses the key(s) of the second keypad that correspond to at least one of the characters/letters—optionally and preferably, the first character thereof. The system may compare the key(s) being pressed during the correction procedure with the corresponding key that was pressed when the information was first input, and, by using the method described above, the system can provide the corresponding precise character(s). Then, by considering the precise character(s), the system proposes a word. By way of illustration, in the specific example above, the system proposes the word “time”, however the user then presses a key 1013 corresponding, inter alia, to the first character “f”, of the desired word—“fire”. By considering/comparing the first key 102 being pressed during the first input information and the key 1013 being pressed during the correction procedure, the system determines that the unique letter common to both of these two keys is the letter “f”. The system thus recognizes that the desired word begins with the letter “f”, and, by considering the first input information and the additional input information the system proposes the word “fire” since this word has the highest priority from among the words within the predefined database of the system. It will be appreciated that the above method is presented by way of example only. Other selection methods for choosing words may additionally or alternatively be defined and supported.

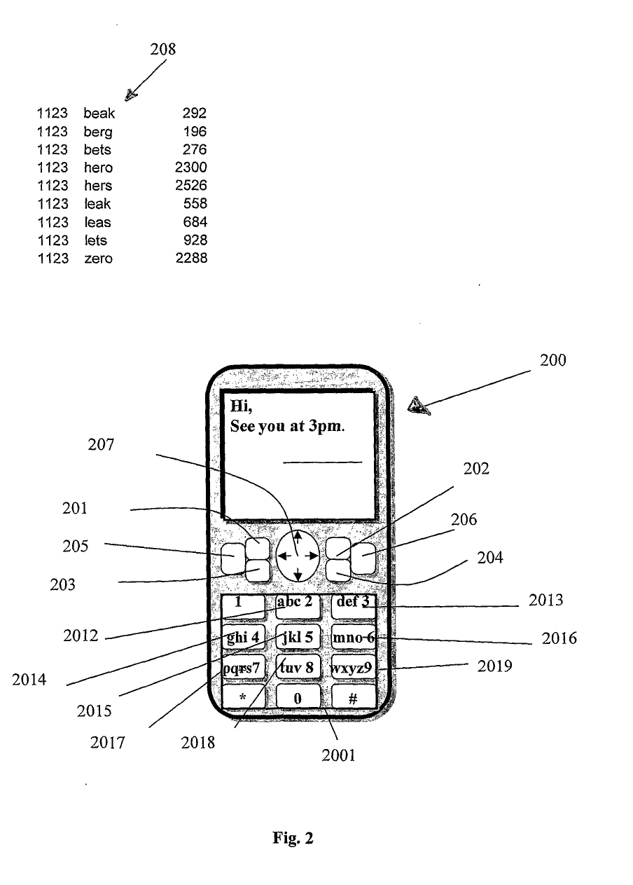

The above-described data/text entry and correction methods provide a simple user-friendly and intuitive system that simplifies the character entry and therefore also simplifies the combined data entry systems, is easily learned and requires minimal mental effort. By way of example, the user may enter a string of characters, such as a word that is not included in the dictionary database of the system, by entering it character-by-character using the two keypads to unambiguously select and input each character in turn, in the manner described hereinabove. However, alternatively, the user may first enter a sequence of characters (a word) using one input means (first keypad) and then go through and correct the sequence using the second keypad i.e. using the correction procedure described herein. This functionality is very useful since in many cases the user may not know in advance whether the word that he wishes to use is within the dictionary or not. By using this approach, the user may enter any word without being concerned as to whether it is supported by the dictionary database 108 or not. He may first provide the first input information (corresponding key presses) through the first keypad 100. If the desired word is not proposed, i.e. does not appear on the screen (e.g. 200 FIG. 2), he may then proceed to the correction procedure of the invention by using the second keypad 1010. The user may first press the key 1013 of the (second) keypad 1010 corresponding to the first character of the desired word (fire). As described above, the system will recognize the character and, according to one method, may propose another word corresponding to the combination of inputted information. If the proposed word is still not the desired word, the user may press a key of the second keypad that corresponds to the second character of the desired word. The system will then suggest another word corresponding to the combined information inputted until this point of time. If the word suggested is still not the desired word, the user may repeat the procedure until the system proposes the desired word. Where the desired word is not included within the dictionary of the system, the desired word is provided by sequentially pressing the keys of the second keypad 1010 corresponding to all of the characters of the desired word.

As an example, considering FIG. 1, if a user desires to enter the word “mixq” which is a word not listed within the dictionary database, he may first press the keys 102, 104, 102, 101, of the first keypad 100. The system may propose the word “time”, which has the highest priority among the words corresponding to the information inputted. Since this is not the user's desired word, the user may proceed to a correction procedure by pressing the key 1016 of the second keypad 1010 that corresponds to the first character “m” of the desired word. The system then determines that the desired word must begin with the letter “m”. By considering the combined input information provided by the user the system may propose the word “mute” since this word has the highest priority among the words within the dictionary that correspond to the combined input information. Since this is still not the desired word, the user may continue the correction procedure by pressing the key 1014 of the second keypad 1010 that corresponds to the second character “i” of the desired word. The system then determines that the second character/letter of the desired word is the letter “i”. By considering the combined input information provided by the user until this time, the system will propose the word “mime” as having the highest priority among the words of the dictionary corresponding to the combined input information, i.e. corresponding to the first input information and beginning with the letters “mi”). Since this is still not the desired word, the user may continue the correction procedure by pressing the key 1019 of the second keypad 1010 that corresponds to the third character “x” of the desired word. The system then determines that the third letter of the desired word is the letter “x”. By considering the totality of input information provided by the user until now, the system may not find any corresponding word in the dictionary, but the system determines that the desired word begins with the chain of character “mix”. If the dictionary includes such a word, the system may propose a word that begins with these characters, with the remaining characters being proposed in accordance with the popularities of words within the dictionary, and, failing that, i.e. if the word is not supported by the dictionary, with letters that are more frequently used, or by some other procedure, perhaps by alphabetical arrangement, for example, or by the final letters inherited from original guessed word without modification. In this specific example, the system has learned the first three letters as being MIX and may propose the chain of characters “mixe”, since “e” is inherited from previous suggestion “mime”, however, this is still not the desired word. The user now may press the key 1017 of the second keypad 1010 corresponding to the fourth letter of the desired word which is the letter “q”. By considering all the inputted information in combination, the system realizes that the last character is the letter “q” and proposes/enters the desired word “mixq”.

The example above may be summarized in the following table:

| | | | | |
|---|---|---|---|---|
| 1st keypad pressing actions | 102 | 104 | 102 | 101 |
| Display after 1^{st} keypad action | | | | time |
| 2nd keypad pressing actions | 1016 | 1014 | 1019 | 1017 |
| Common/Provided characters | M | i | x | q |
| Display after 2nd keypad action | Mute | mime | mixe | mixq |

In some embodiments of the invention, when the system encounters a user entered prefix which does not correspond to any word in the dictionary, the system displays only the characters entered unambiguously (e.g., by pressing keys from both keypads 1010 and 100). Alternatively, the system continues to provide guess words including the number of characters entered using the first keypad, for example providing for each ambiguous character, the most commonly used possible character or keeping the ambiguous character as displayed previously.

The system may support different methods of correction. For example, if the user knows in advance that the word that he desires to enter is in the dictionary database and the system does not propose it after entering the first input information, according to one method, the user may use a predefined interaction such as scrolling or using correction keys of the system to navigate between the words of the dictionary that correspond to the input information provided by the user. However, for example, if the user is not sure that the desired word is in the dictionary database; he knows that it is not in the dictionary database, or he simply does not like the previous correction method or it is not supported, then he has the choice of entering his desired word by typing it in twice: first by typing it using the keys of the first keypad, and then subsequently, confirming/amending the selection by retyping at least a portion thereof via the keys of the second keypad.

It is noted that according to one method, after entering the first input information and causing a non-desired word to be proposed by the system, the additional input information provided by the user via the second keypad may cause the system to precisely recognize the corresponding letter(s) of the word, changing the letters that are wrong, without changing other letter(s) of the proposed word. In some embodiments of the invention, the processor managing first keypad 100 learns the corrections that the user commonly performs and accordingly changes the guess words it provides. For example, if a specific key stroke sequence could be interpreted as word1 or word2, and word1 is more commonly used by the general population than word2, the system will originally provide word1 as the guess for the specific sequence. However, if after several times the sequence is provided it is determined that the specific user uses word2 more often than word1, the system will, thereafter, use word2 as the guess word for the specific keystroke sequence.

It is noted that according to another method, the user may enter a word by precisely inputting it character by character. For example for entering the chain of characters ‘mixq” the user may consecutively press the keys:

102, then 1016, (e.g. providing “m”)

104, then 1014, (e.g. providing “i”)

102, then 1019, (e.g. providing “x”)

101, then 1017, (e.g. providing “q”).

According to one embodiment of the invention, ambiguous characters that are common to both the first and second keypads may include special characters and/or numbers, such that a key from the keys of the first keypad and a key from the keys of the second keypad may have at most one common character, which may be a letter, a number or a punctuation mark, for example.

In some embodiments of the invention, instead of the keys of the second keypad being interpreted as relating to the first letter of the current word, the keys of the second keypad are taken as relating to the most recent position. Thus, at any position during the entry of a word, the user may enter a precise character of said word at that position. For example, pressing the keys 102, 101, 102, 102 on the keypad 100 may correspond to the words “that” and “text”. If the user desires to enter the word “text”, according to this embodiment, he may press the keys 102, 101, 102, of the first keypad, then press the key 1019 of the second keypad 1010 (e.g. the system determines that it must combine the last key press 1019 and its preceding key press 102 to provide a precise character, in this example, the only common character between those two keys is the letter “x”), and finally may press the key 102. By considering the key presses provided using the first keypad and considering the precise letter (“x”) the system suggests the word “text”.

It is noted that although the above description relates to each key as corresponding to a single group of symbols, since space is typically limited in portable devices, in some embodiments a single key may correspond to two or more groups of symbols based on different user actuations. For example, the same key may correspond to different groups of symbols for short and long actuations and/or may correspond to different groups of symbols for different state selections (e.g., shift pressed or not-pressed). Using such methods, each of the first and second sets of keys may include fewer keys and/or one or more keys may be included in both the first and second sets, depending on the user actuation used.

It will however be noted, that use of two distinct keypads for the first and second sets of keys may, for some users, be easier and less confusing. In another example, the system may have a few keys wherein the letters of a language are distributed and assigned to single pressing actions on the keys, and wherein the same letters are also distributed and assigned to a different key stroke, such as a long pressing action on the keys, such that the letters assigned to one single pressing action on a key and the letters assigned to a long pressing action on the same key, have at most one common letter. This embodiment requires fewer keys, and may, for example, be beneficial for entering text using small devices only having room for only limited keypads.

It will also be understood that where, in the descriptions above, a first keypad having four ambiguous keys and a second push-button telephone number pad type keypad are used by way of example, for demonstration purposes, obviously, other first and second sets of keys each having different numbers of keys for assigning substantially all of the letters of a language to each of the sets of keys in the manner described above (e.g. an ambiguous key of a first keypad and an ambiguous key of a second keypad have at most one common character) may be used.

Optionally, the digits 0-9 available on a telephone keypad may be entered using the data entry system of the invention. According to one embodiment of the invention, if the current word being entered does not include positions which are still ambiguous, actuation of a key of the second keypad is interpreted as relating to symbols not related to by the first keypad, such as digits, for example.

According to another embodiment, if the (single) key press provided by the user through the second keypad cannot be considered by the system as corresponding to correcting a word, then preferably, the key pressing action may correspond to entering a predefined symbol such as the digit assigned to the interaction with the key of the second keypad.

Furthermore, if a pressing action is provided using a key of the first keypad and another, typically consecutive pressing action is provided on a key of the second keypad, and those two keys do not have a common character, then a predefined symbol corresponding to the (e.g. consecutive) pressing action on the two keys may be provided. This may permit some special characters to be assigned to different (e.g. consecutive) pressing actions.

According to one embodiment of the invention, at any moment during the entry of a word, by pressing the ambiguous keys of the first keypad, the user may proceed to the word correction procedure by providing a first type of pressing action such as a single/simple pressing action on a corresponding key of the second keypad. In this case, according to one method, the system may be predefined to relate the key pressing action to the first ambiguous key pressing action as provided by the user through the first keypad and corresponding to the user's desired word. If the user desires to relate a pressing action provided on the second keypad to the last ambiguous character of the undesired proposed word, he may use another type of pressing action such as a double-pressing action on the corresponding key of the second keypad, for example.

By way of example, FIG. 2, shows the data entry system of an embodiment of the invention having a first keypad that includes six keys 201-206 and the multi-directional key 207, wherein four of its keys 201-204 have letters of a language distributed thereto, such as to duplicate the keys 101-104 of the keypad 100 of FIG. 1, and a second keypad being a telephone-type keypad 2001. By considering the exemplary portion 208 of the dictionary database of the system, at the end of the entry of the key presses 201, 201, 202, 203 (e.g. the first input information), the system may propose the word “hers” as having the highest priority which may be the highest objective probability of usage, the highest subjective probability for the specific user, or some other criterion.

In some embodiments of the invention, if the user single-presses the key 2015 of the second keypad, then the system may relate that pressing action to the first ambiguous character entered by the user through the first keypad. In this case the system relates the pressing action to the first letter of the desired word. Thus the pressing action on the (numeric) key 2015 and the pressing action on the (cursor control) key 201, have (e.g., can be related to) one common character which is the letter “l”. The system may propose the word “lets” since this has the highest priority from among the words corresponding to the combined input information, i.e. the first input information and the information provided during the correction procedure of the invention, for example. It is noted that according to this embodiment, for example, if the first character(s) had been entered precisely, the system may relate the pressing action to the first ambiguous character after these precisely entered character(s).

Accordingly, in such embodiments, an out-of-dictionary word may be entered either by precisely entering its characters, spelling it out, character by character, for each character by pressing the corresponding ambiguous key of the first keypad and the corresponding key of the second keypad, or by pressing the ambiguous keys of the first keypad corresponding to (all of) its characters, and then pressing the (ambiguous) keys of the second keypad corresponding to (all of) its characters.

In other embodiments of the invention, if the user provides a predefined pressing action (keystroke), for example, by double-pressing the key 2015 of the second keypad, the system relates that pressing action to the last ambiguous character entered by the user, which is generally the last pressing action provided through the first keypad. Accordingly, in this example, the (double) pressing action on the key 2015 and the pressing action on the key 203, have one common character which is the letter “k”. The system may propose the word “leak” as having the highest priority from among the words corresponding to the combined input information.

It is noted that according to one method, the system may memorize the location of the precise character(s) or letter(s) within the word, therefore, during the correction procedure when the user interacts with (e.g. presses the key of) the second keypad, the system compares each key press with the key press corresponding to an ambiguous key press of the first keypad, such as the key press that corresponds to a non-precise character provided during the entry of the first input information. According to one embodiment, the user may use a predefined interaction such as a predefined pressing action on a predefined key to delete the information provided earlier by the user, corresponding to providing precise character(s) within the word and consider only the ambiguous key presses provided through the first keypad so that the next time that the user proceeds to enter additional input information during the correction procedure, the system relates to the information to the first key press provided by the user through the first keypad.

According to one embodiment of the invention, the correction procedure for entering a precise character of a word may correspond to any of the characters of the word that correspond to the additional input information provided by the user. For example, after entering the first input information by, e.g. pressing the keys corresponding to the letters of the desired word, if the system proposes a non-desired word, then the user may provide additional information, such as described hereinabove or in some different manner, corresponding to at least one of the characters of the desired word. The system may consider the additional information with any of the relevant ambiguous characters of a word corresponding to the first input information (e.g. key presses) and proposes the word (e.g. preferably, having the highest priority among the words within the dictionary) corresponding to the combined information. If the proposed word is not the desired word, the user may either press on a predefined key such as a “scroll/correction” key to scroll between possible words corresponding to the combined information, or he may provide additional information, perhaps corresponding to an additional letter of the word as described above.

By way of example, by considering FIG. 2, and the portion 208 of its dictionary database and by using the data entry system of the current embodiment, at the end of the entry of the key presses 201, 201, 202, 203, the system may propose the word “hers” since this word has the highest priority. At this time, the user may proceed to the correction procedure by, for example, pressing the key 2015 of the second keypad. According to this method, the system will determine that the word desired by the user may have one of the letters “jkl” in any location within the desired word. By considering the key 201 and the key 2015, the system determines that if the user's pressing action on the keys 2015 is intended to any of the first and/or the second letter of the desired word then said letter is “l” (e.g. letter “l” is the only common letter between the keys 201 and 2015). First keypad key 202 has no common letter with the second keypad key 2015, therefore the third letter of the desired word is not any of the letters “jkl”. Finally, first keypad key 203 and second keypad key 2015 share the common letter “k”. This implies that the user's pressing action on the keys 2015 is intended to set the last letter of the desired word as the letter “k”. The words (e.g. the selection):
“beak”
“leak”
“leas”
“lets”
   correspond to the combined information. The system may propose the word “lets” having the highest priority from the available words. If this is not the desired word, then according to one method, the user may, for example, press a correction/scroll/next key so that the system proposes the next word from among available corresponding words, or according to another method, he may enter an additional input by pressing another key of the second keypad as described above.

For example:
if the user presses the key 2015 again, the system proposes the word “leak” wherein two of its characters (e.g. “l, k”) correspond to two pressing actions on the key 2015, in cases where more than one word corresponds to the combined information, according to one method the system may propose the word having the highest priority among them), or
If the user presses the key 2017, the system may look for a word within the selection above wherein one of its letters corresponds to the key 2015, and another letter of said word corresponds to the key 2017. There are two such words, “lets”, and ‘leas”. The word “lets” was already proposed to the user, therefore, the system may propose the word “leas”. It must be noted that the examples of the methods of searching a word based on the (combined) input information provided by the user are exemplary methods only. Other search methods based on user's (combined) input information may be substituted or additionally considered. Various appropriate searching methods are available as known.

It will be noted that the examples shown hereinabove are provided for demonstrating the principles of data entry systems in accordance with the invention. Other examples may be considered by people skilled in the art.

As described hereinabove, in addition to correcting the proposed undesired word, the second keypad may also be used to enter other symbols such as special characters and numbers and functions, thus the system may provide the full range of keys and functions provided by a full PC keyboard. According to one embodiment, means such as, one or more mode keys may be used to switch the system into another symbol entry mode, while according to another embodiment of the invention, in order to simplify the user's interaction, some predefined rules may be considered for that purpose so that, in at least some cases, the system automatically enters into the other symbol entry mode/procedure.

According to one method, after pressing a key of the first keypad, if the next key press is provided through the second keypad then the system compares the keys being pressed to see if they offer a common letter:
Where they have a common character, the system may proceed to the correction procedure of an embodiment of the invention as described, and may propose a new word.
   If the correction procedure is not what the user desires to do, according to one method, he may inform the system that this is the case by pressing a predefined key such as the “backspace” key, or some other means. The system may go one step back and display the previous word, and then may display the special character corresponding to the pressing action provided through the second keypad. In this case, for example, if the pressing action provided by the user on the second keypad is a single-pressing action, then the system may propose the digit assigned to the key of the second keypad. Also as for example, if the pressing action provided by the user is another type of interaction such as a double-pressing action, perhaps a ‘gliding’ action if the key is a virtual key on a touch sensitive surface such as on a touch-screen, then the system may propose a special symbol such as a punctuation mark or a function assigned to a predefined interaction with the ‘key’ of the second keypad.
Alternatively, if the two keys from the two keypads do not share a common character, then the user may proceed to enter corresponding special symbol(s). The arrangement/assignment of the special symbols on/to the keys of the second keypad will be described in more detail, hereinbelow.

If a user presses a key of the second keypad and the preceding key press does not relate to the entry of a word or to correction of a proposed character/word, then the system may proceed to entering corresponding special symbols such as the digit assigned to said key.

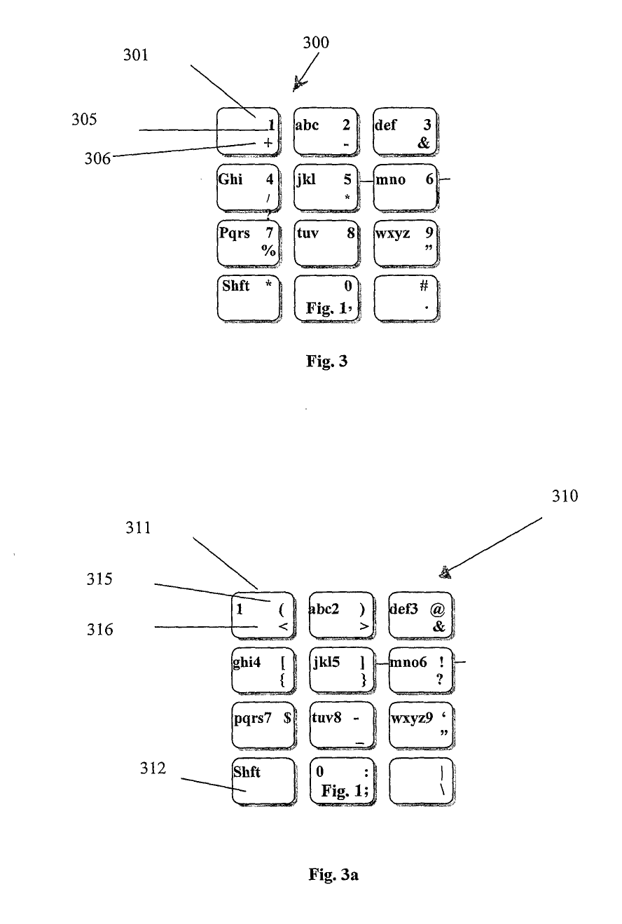

In addition to or in replacement of arrangement/assignment of special symbols to the keys of the first keypad as described in different patent applications previously filed by the applicant, different methods of arrangement/assignment of the special symbols on/to to one or more predefined interaction with the keys of the second keypad may be considered. FIG. 3 shows an exemplary second keypad 300, specifically an alphanumeric telephone-type number pad type keypad in this example) of the invention, wherein a single pressing action on a key may correspond to a predefined character such as the character shown on the upper-right side of the keys (for example, character “1” 305 on the key 301), and a double pressing action on a key may correspond to another predefined character such as the character shown on the lower-right side of the key (e.g. example, character “+” 306 on the key 301). By way of alternative example only, FIG. 3a shows an (e.g. the same) exemplary second keypad 310 (e.g. the same telephone-type keypad) of the invention, wherein a pressing (e.g. and holding) a shift key 312 and a single pressing action on a key may correspond to a predefined character such as the character shown on the upper-right side of the keys (e.g. example, character “(” on the key 311), and a double pressing action on a key may correspond to another predefined character such as the character shown on the lower-right side of the key (e.g. example, character “<” on the key 311).

As discussed previously, the first and the second keypad may have virtually any number of keys, any key configuration, any type of assignment (e.g. distribution) of the symbols/characters of a language to each of the first and the second keypad such that:
any of the (ambiguous) keys of the first keypad and any of the (ambiguous) keys of the second keypad have at most one common (e.g. similar) character and;
preferably the assignment of the characters (e.g. letters) to the (e.g. four) ambiguous keys of the first keypad being such that to maximize the likelihood that the system proposes the user's desired word based on the key presses corresponding to said word provided through the first keypad alone.
   Preferably the system also uses different types of interaction with the keys, etc., to permit complete duplication of a PC keyboard in the easiest manner.

As discussed previously, the first and second keypad may have any number of keys, any key configuration, any type of assignment (e.g. distribution) of the symbols/characters of a language to each of the first and the second keypad. Optionally, the characters are arranged such that each pair consisting of a key from the first keypad and a key from the second keypad has at most one common character. Alternatively, one or more pairs of first and second keys may have two or more common characters, which have a very low interchangeability rate, such that the system will guess in nearly all cases which one is intended. For example, in one embodiment, the characters ‘?’ and ‘q’ may be located on the same first and second keys, as ‘?’ is generally placed at the end of a word and ‘q’ is generally not used at the end of a word. Alternatively, one or more pair of first and second keys may have two or more common characters when an additional method is provided for the user to resolve ambiguities, such as speech recognition and/or identification of lip or facial movements.

In some embodiments of the invention, the letters are assigned to the keys in a manner which maximizes the chances that the system will guess the intended word as early as possible. For example, the second keypad may be arranged using the known arrangement on telephone devices according to the order in the alphabet. The first keypad is then arranged such that letters for which replacing one for another in many words would result in another valid word, are not included on the same key of the first keypad.

By way of specific example, d and s are both common word endings at the end of many words such as “saved” and “saves”, and are thus preferably not on the same key.

In a similar manner, two or more of the vowels a, e, i and o are preferably not included on the same key. In some embodiments of the invention different key arrangements of the first keypad are used for different languages in the same device or in different devices sold in different countries. Alternatively, for standardization across platforms and countries, a single letter arrangement may be preferred for all languages using a common alphabet even if the word prediction in some languages is degraded slightly as a result.

The first keypad arrangement preferably avoids placing two letters from the same second key on a single key of the first keypad. Optionally, simulations are performed using a dictionary with frequencies and a plurality of different key arrangements to select an arrangement which achieves a highest percentage of first time guesses of desired words.

### Additional Input Methods

In some embodiments of the invention, in addition to using two keyboards having ambiguous keypads, the system allows data entry through further means, such as speech recognition. For example, after pressing a key ambiguously corresponding to a plurality of characters, the user may say the name of the desired character and/or the sound of the desired character. In a further example, after pressing a sequence of a plurality of characters corresponding to a desired word, the user may say the word in order to help the system choose the intended word. Other methods of using speech to determine the user's intention in pressing ambiguous keys may be used, such as the methods described in PCT publication WO05/122401.

Optionally in these embodiments, in addition to the above mentioned considerations for the assignment of the characters/letters to the (e.g. four) keys of the first keypad, the assignment of the characters to said keys of the first keypad may be such that characters/letters having ambiguously resembling speech characteristics are assigned to different keys of the first keypad.

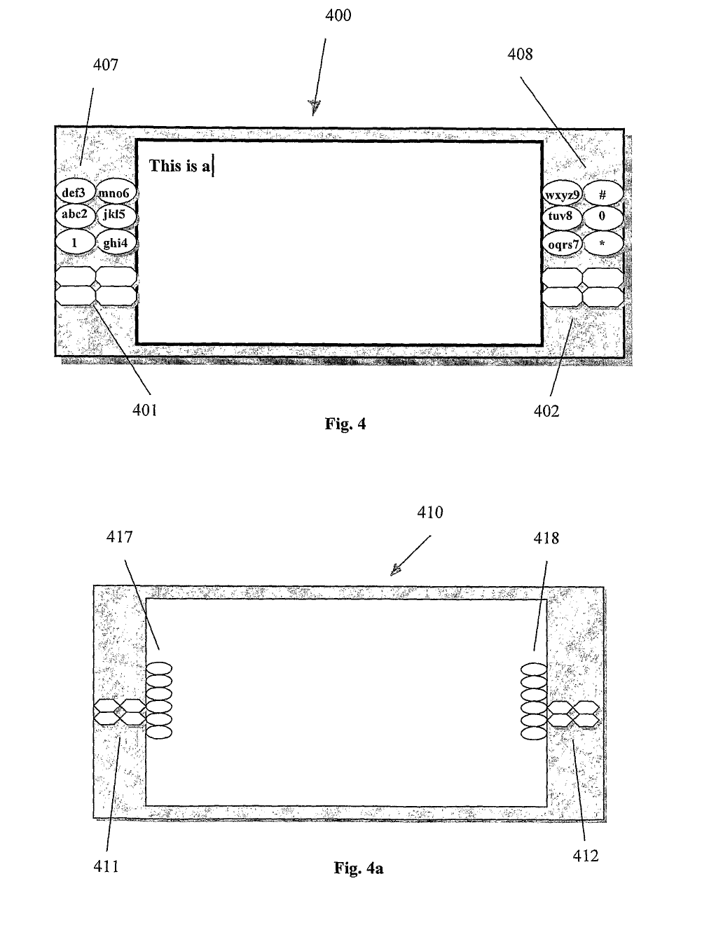

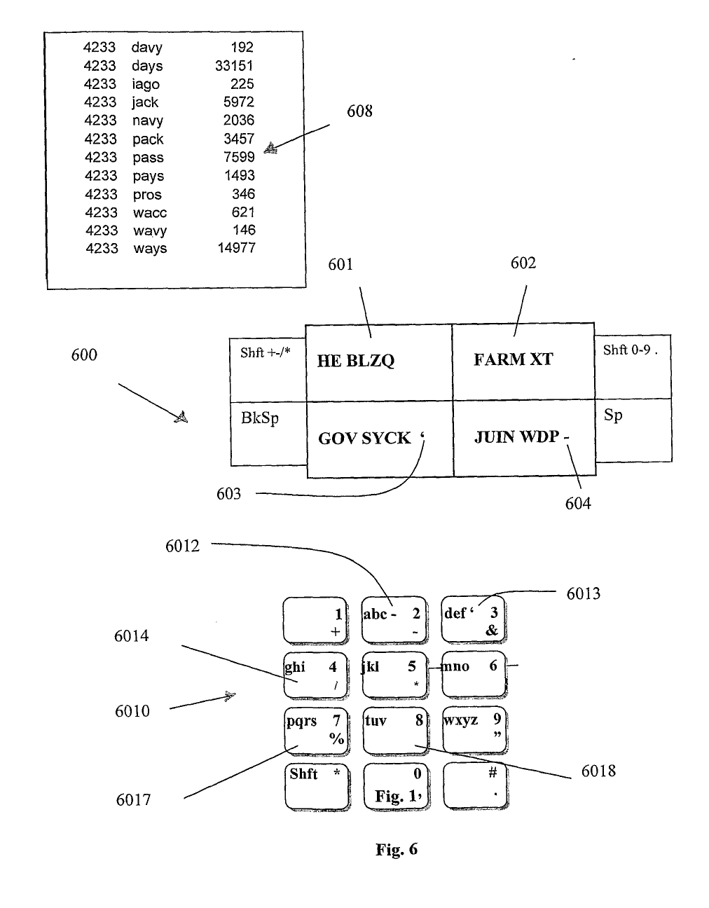

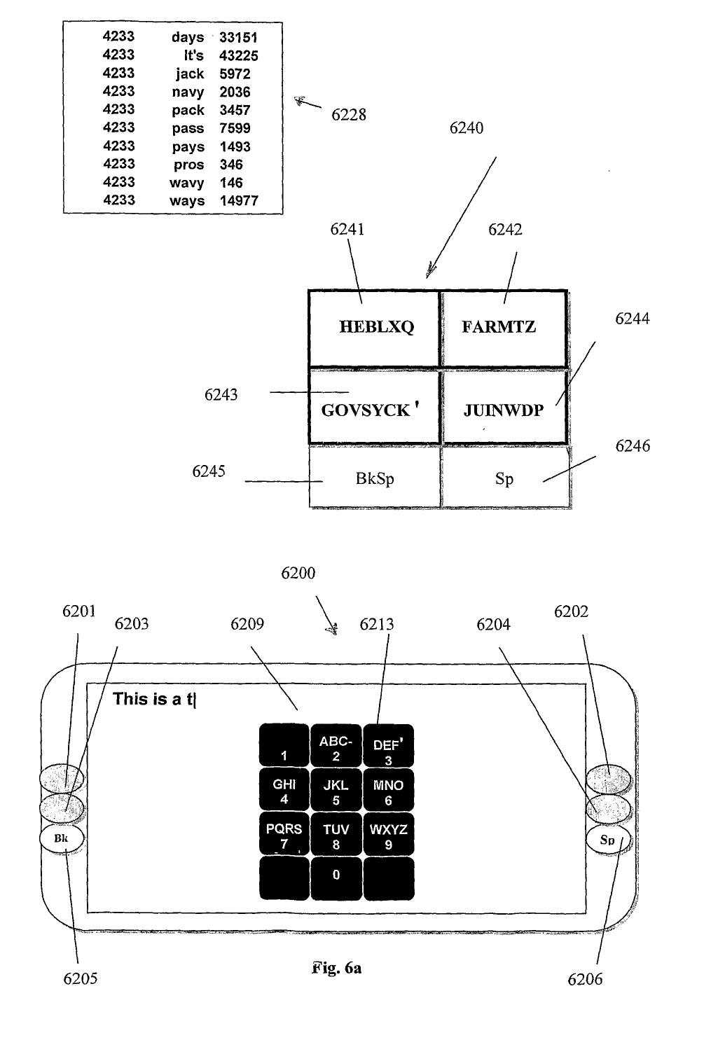

Depending on the device or the environment, the key configuration may be different. FIG. 4, shows as an example, a mobile device being used in landscape position. The first keypad of the invention duplicating the keys of the keypad 100 of FIG. 1 (e.g. in this example, the first keypad includes two additional keys as shown in different patent applications filed by this inventor) or the keypad 600 of FIG. 6, may be split into two portions 401, 402 on opposite sides on the device. Also, the second keypad (in this example, a telephone-type keypad) may also be split into (two) portions 407, 408, on the opposite sides of the device. Splitting the keys of the keypad(s) of the invention may be performed in accordance with any method known in the art, such as any of the embodiments in PCT publications WO01/131788, titled “Integrated Keypad System”, WO03/007288 titled “Features to Enhance Data Entry Through a Small Data Entry Unit”, WO04/095414 titled “System to Enhance Data Entry in Mobile and fixed Environment”, WO05/122401 titled “System to Enhance Data Entry in Mobile and fixed Environment”, WO07/114833 titled “Data Entry System”, and PCT application IB2007/004481. In one example, the telephone-type keypad is rotated 90 degrees and then split such that to keep its original form.

As mentioned before, at least one of the keypads may be an on-screen keypad so as to permit having fewer hard keys also permitting to design different on-screen key arrangements. FIG. 4a, shows the second keypad 417, 418 of the FIG. 4. having on-screen form factor.

### Keypad Layouts

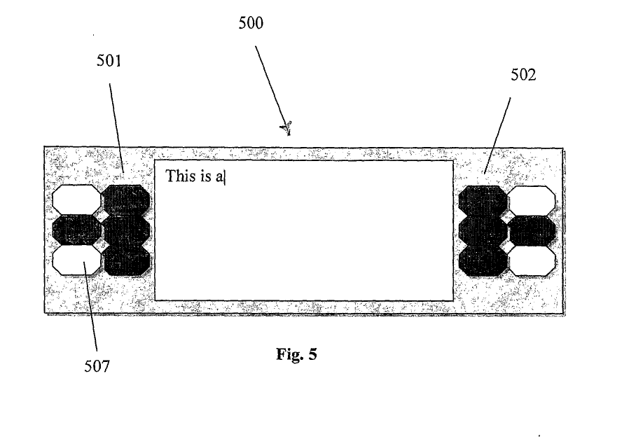

As mentioned hereinabove, instead of two different keypads the system may use two different types of interaction with one keypad to duplicate two keypads. FIG. 5 shows as an example, a keypad 500 of the invention having twelve keys. In this example, eight of the keys (e.g. the darker keys) may duplicate a first keypad of the invention wherein to four of its keys the letters of a language are assigned in a manner described above. In this example, said twelve key may also duplicate the keys and the letter assignment of a telephone-type keypad (e.g. the second keypad). A means such as pressing a predefined key may cause to system to switch between the two modes/keypads. For example, in order to enter a word, the user may use (e.g. press) the keys of the first keypad (e.g. the darker keys), and by pressing a “mode” key 507, the system may switch to the second keypad (e.g. in this example, the 12 key telephone-type keypad mode) mode, and proceed to other tasks such as correcting a word or entering special characters. Another pressing action on the “mode” key may enter the system into the first keypad mode. It is understood that instead of pressing a mode key and releasing it to switch from a first keypad/mode to a second keypad/mode, a press and holding action on said key may also cause switching from a first keypad/mode to a second keypad/mode such that when the user releases said mode key, the system returns back to the first keypad/mode. In this case, press-and-holding the mode key and pressing a key of the keypad may correspond to pressing a key of the second keypad (or vice-versa).

It is noted that although in different patent applications filed by this inventor, after proposing a word by the predictive data entry system of the invention, a means such as a correction means or next/scroll key has been mentioned/described to scroll within the words corresponding to the (combined) information provided by the user (e.g. corresponding to the key presses provided by the user and beginning with the same character), other methods for the same purpose (e.g. correcting procedure) may be considered. For example, according to one method, after the system proposes a word (based on user's input information), if the proposed word begins with the same character as the desired word, the user may provide an input information corresponding to the same beginning character and the system may propose the next/another word that corresponds to the user's input information provided during the entry (and correction procedure) and that begins with the same letter as the word that the system proposed the last time. If the user repeats said procedure, the system may propose another next corresponding word as just described, and so on. For example, by considering the FIG. 2, at the end of the entry of the key presses on 201, 201, 202, 203, the system may propose the word “hers” having the highest priority.
if the user speaks the name of (e.g. says) the letter “h”, (e.g. or presses the key 2014 of the second keypad, or presses the “h” key of a full PC keyboard, etc.), the system may propose the next word that corresponds to the user's input information and that begins with the same letter as the last word. In this example, the system may propose the word “hero”.
According to another example, after the system proposes the word “hers”. if the user desires to enter the word “leak”, he may first say the letter “l” (e.g. or may press the key 2015 of the second keypad, or may press the “l” key of a full PC keyboard, etc.). The system may propose the word “lets”. The user may again say the letter “l” (e.g, or may presses the key 2015 of the second keypad, or may press the “l” key of a full PC keyboard, etc.). the system proposes the word “leas”. The user again may say the letter “l” (e.g, or may press the key 2015 of the second keypad, or may press the “l” key of a full PC keyboard, etc.). At this time the system may propose the desired word “leak”.

The data entry system of the invention using two ambiguous set of keys (e.g. two keypads) wherein to (at least some of the keys of) each of said keypads one set of at least the letters of the alphabet of a same language are assigned in a distributive manner such that a key of the first keypad and a key of the second keypad have at most one common character/letter, has many advantages. Through this system the user may enter in-dictionary and out-of-dictionary words easily and naturally (as described before). For example, during the meetings the user may take notes by using the first keypad only. After the meeting, the user may display the document, go through it and correct the words by pointing to (e.g. locating the cursor at the end of the) word to be changed, and proceed to the correction procedure by using the second keypad. By considering the non-desired word and accordingly considering the first key presses (e.g. first input information) that provided said non-desired word (e.g. or chain of characters) and the key press(es) that the user provides through the second keypad, the system may propose the desired word correspondingly/accordingly.

It is understood that in addition to the first and second keypad, the system may have/use other keys such as arrow keys or mouse keys, etc. The system may also include word-completion software. The second keypad may also include a second/additional shift key to permit the entry of more characters or portion-of-a-words as described in different patent applications field by this inventor.

It is noted that according to one embodiment, during the correction procedure, the input information provided by the user may be predefined to correspond to the last character of the desired word, and accordingly the scrolling system through the words may be based on the last character of the word.

As mentioned before, at least in some embodiments of the invention, at any moment during the entry (or correction procedure) of a word, the user may proceed to correcting the word/chain-of-character proposed to the user (until that time) by providing a predefined type of pressing action such as a single/simple pressing action on a corresponding key of the second keypad. Also as mentioned before, according to one embodiment, the system may be predefined to relate said key pressing action to the first ambiguous character of the word (e.g. or chain of characters) proposed by the system. Hereafter, some examples:

Optionally, according to one method, if the beginning character(s) of the proposed word is/are precisely entered earlier, the system may relate said pressing action on the key of the second keypad to (the key of the first keypad corresponding to) the first ambiguous character position after said precise character(s) within said proposed word (e.g. relates it to the first ambiguous character of the proposed word). Obviously, said ambiguous character may be located between two precise characters of said proposed word. The next such predefined type of pressing action on the second keypad may predefined to correspond to (the key of the first keypad corresponding to) the next ambiguous character of the proposed word.

Optionally, according to another method, if the pressing action through the second keypad can not be interpreted by the system as being related to the correction procedure of/relating-to a proposed word, such as for example any of the following situations:
if there is no ambiguous characters within the (proposed) word
the pressed key of the second keypad does not have a common character with the key of the first keypad corresponding to the first ambiguous character of the proposed word
after an end-of-word signal
(e.g., the cursor being located) after a special character/function (e.g. punctuation mark, Space, etc.)
no proposed word to correct
beginning of a word
etc.,
   then, the system, preferably, may relate said pressing action on the key of the second keypad to entering a predefined special character/function also assigned to said pressing action on the corresponding key of the second keypad (e.g. the assignment of the special characters to the keys of the second keypad has already been described in detail before and will be more described through examples later in this application.).

For example:
if said pressing action on the key of the second keypad is a single-pressing action on said key, then as described and shown before, it may be related to entering the digit assigned to said key.
if said pressing action on the key of the second keypad is a double-pressing action on said key, then as described and shown before, it may be related to the entering the another special character assigned to said key.
it is noted that as an example, if said pressing action on the key of the second keypad is a predefined pressing action such as pressing a shift key and providing a single/double-pressing action on the key of said second keypad, then, in a predefined manner, the pressing action is not related to the correction procedure of the invention, then as described and shown through exemplary drawings, said key pressing action may be related to entering the corresponding special character/function.
if the pressing action on the key of the second keypad can be interpreted by the system as being related to the correction procedure (of a proposed word) of the invention, but the user does not intend to correct the proposed word (e.g. the proposed word is the desired word, but the user wants to for example enter a special character at the end of said proposed word) then, according to one predefined method, after the system proposes a new word based on said pressing action on the key of the second keypad, the user may provide a predefined pressing action on a predefined key (e.g. such as pressing the “Backspace” key and the system preferably, in a predefined manner, may relate said pressing action on the second keypad to entering a special character also assigned to said pressing action on the key of the second keypad. In this case the system may re-print (e.g. go back to) the previous proposed word and provide the corresponding special character (e.g. at the end of said word).
Obviously, for the same purpose, according to another method, before providing said key pressing action through the second keypad, the user may provide an end-of-the-word signal such as a predefined pressing action on a predefined key, so that to inform the system that the proposed word is accepted, and that the next pressing action on a key does not relate to entering (additional characters to)/correcting the proposed word. Then, the user may provide said pressing action through the second keypad, and the system provides the corresponding special character.

In the above description, the pressing action through the second keypad is described to be related to the first ambiguous character of the current word. In other embodiments, the pressing action of a key of the second keypad relates to the most recently entered character of the current word and subsequent actions of keys of the second keypad relate consecutively to earlier characters of the word until the beginning of the word is reached. In still other embodiments of the invention, actuation of a key of the second keypad is considered to relate in the alternative to any of the (e.g. ambiguous) positions of the current word, and the processor uses this constraint in selecting which guess word is displayed.

As described before, although preferably generally, the predefined pressing action relating to entering the letters/characters of a word and/or correcting said word, on the first and the second keypad, are single-pressing actions on said keys, it must also be noted that as described before, another predefined type of interaction on said key of the second keypad such as a double-pressing action on said key may corresponds to correcting the last ambiguous character of the proposed word, and so on (reversing the order of the related considering characters in the correction procedure, from the last to the first ambiguous character).

Additionally, as described in different patent applications field by this inventor, the system may have a predefined function key such as a next/correction key, wherein a/each pressing action of said key (e.g. alone), may provide the next word within dictionary of the words of the system, that corresponds to the (combined) input information (e.g. ambiguous keys presses, and precise characters if any) provided by the user. This matter has already been described in detail before.

As mentioned before, the ambiguous characters assigned to (a predefined interaction with) a key (e.g. of the first keypad and obviously, the second keypad) may include special character(s). Said character(s) may be included within (being part of) some of the words of the dictionary database of the system and being predicted by the data entry system of the invention. For example, FIG. 6 shows as an example, a first and a second keypad of the invention wherein the key 603 of the first keypad 600 includes the special character “'”, and the key 604 includes the character “-”. The same special characters are respectively assigned to the keys 6013 and 6012 of the second keypad. The assignment of the ambiguous characters, including letters and special characters, to the (ambiguous) keys of the first and the second keypad, is done in a manner such that the combined (ambiguous) characters on the few (e.g. in this example, four) ambiguous keys of the first keypad and the combined (ambiguous) characters on the second (e.g. in this example, telephone-type) keypad are distributed on each of the keypads, such that an ambiguous key of the first keypad and an ambiguous key of the second keypad may have at most one common character. For example, if the user wants to enter the word “it's” (e.g. that in this example is not included within the dictionary of words of the system), the user may press the keys 604, 602, 603, 603. The system may propose the word “days” having the highest priority among the words corresponding to said input (e.g. key press) information. The user then, may press the keys 6014, 6018, 6013, 6017, corresponding to the desired characters (e.g. “i, t, ', s”) of the desired word, through the second keypad.
the first key being pressed through the first keypad and the first key being pressed through the second keypad have one common character, “i”.
the second key being pressed through the first keypad and the second key being pressed through the second keypad have one common character, “t”.
the third key being pressed through the first keypad and the third key being pressed through the third keypad have one common character, “'”.
the fourth/last key being pressed through the first keypad and the fourth key being pressed through the second keypad have one common character, “s”,
   therefore, the system provides the chain characters/word “it's”. Obviously, the system may add said word to its dictionary of words such that the next time it can be predicted through the word predictive methods of the system.

In some embodiments of the invention, however, the apostrophe (“'”) is only included in a set of special characters and is not provided in the first and/or second ambiguous key actuations. In order to add an apostrophe in the middle of a word, the user optionally needs to use a state selection key actuation and the key corresponding to the apostrophe in the special state. The system will then only propose guess words that have an apostrophe in the desired position. If the word with the apostrophe is not in the dictionary, the user will optionally need to enter each of the remaining characters of the word using both the first and second sets of keys. In some embodiments of the invention, the system may then add the word to the dictionary for future use.

As an example for entering a word of the dictionary including a special character, FIG. 6a shows a device 6200 in accordance with another embodiment of the invention. Device 6200 includes a first keypad/keyboard, which for convenience is split into two portions, one located on one side of the device, e.g., the right, and a second portion on an opposite side, e.g., the left side. In this example, the second keypad/keyboard is a telephone-type on-screen keypad 6209. The second keyboard in this embodiment is located between the two portions of the first keyboard. The positioning of the first keyboard on the periphery of device 6200 allows easy access by both hands of the user, each hand accessing one portion of the keyboard. Optionally, the split keyboard is the keyboard which is mainly used by the user for inserting text, while the second keyboard, located between the portions of the first keyboard is used less frequently, for corrections and/or for special characters used less frequently. It is noted that in stating that the second keyboard is between the portions of the first keyboard, it is not necessary that the second keyboard be precisely along a line connecting the two portions of the first keyboard, but rather may be distanced (e.g., above or below) such a connecting line.

Optionally, the first keypad has six keys 6201-6206 that represent the character and function arrangement schematically illustrated by boxes 6241 to 6246 of an arrangement 6240. As shown, keys 6201-6206 do not have imprinted on them the letters to which they correspond, as the user's fingers will generally obstruct the view of such imprinting on the keys. In some embodiments of the invention, the processor of device 6200 displays the key arrangement 6240 on its screen and/or the key arrangement is permanently imprinted on the device body, e.g., its frame.

In addition to the ambiguous letters, the embodiment of FIG. 6A illustrates a key 6243 of the first keypad that also (ambiguously) includes the character “'” (e.g., apostrophe). By considering the portion 6228 of the exemplary dictionary of the words of the system, if the user desires to enter the word “it's” he may press the corresponding keys 6244, 6242, 6243, 6243, of the first keypad. By considering the key presses provided by the user, the system may propose the word “it's” having the highest priority among the words of the dictionary that corresponds to said key pressing actions. If the system does not guess the word correctly, the user can use the second keypad 6209 to indicate the desired words and can use key 6213 to indicate an apostrophe. Additional symbols may be added to other keys by those skilled in the art.

As mentioned before, the user may write a text and then later go through the words within the text, and by selecting/pointing-to a non-desired proposed word he may proceed to correcting/changing it. (Accordingly,) according to one embodiment of the invention, for easier user's manipulation, the system may have a browsing means to navigate back and forth within the text, on word level basis (e.g. a pressing action on a first or second predefined key (e.g. or, a first or a second predefined pressing action on a key) may locate the cursor at the end of the next word or the previous word, respectively.

The first and the second keypads may have any arrangement of assignment of characters/letters to at least some of their keys as long as they comply with the principles of a word predictive data entry and correction system of the invention using two ambiguous set of keys (e.g. two keypads) such as wherein a key of the first keypad and a key of the second keypad have at most one common character/letter, as it has been described before. For example, the letters of a language may be assigned to few (e.g. four) keys of the first keypad in QWERTY order or alphabetical order, etc., and the letters of the language being assigned to/distributed-on the keys of the second keypad in a manner that complies with the mentioned principals also for example such as allowing high word guessing rates by the system.

It must be noted that although in different paragraphs of this patent application for easier description, principles of a word predictive data entry and correction system of the invention using two ambiguous set of keys (e.g. two keypads, e.g. a first set of input signals and a second set of input signals) wherein an ambiguous key of the first keypad and an ambiguous key of the second keypad have at most one common character/letter, was described, obviously, the letters/characters of a language may be assigned to predefined pressing actions on the keys of each of a first and a second keypad, such that a predefined pressing action corresponding to (ambiguous) characters of any of the keys of the first keypad and a predefined pressing action corresponding to (ambiguous) characters of any of the keys of the second keypad have at most one common character/letter. This principle may apply to those paragraphs.

It must be noted that the system may use any additional type of input means with the keypad of the system using few keys (e.g. the first keypad in the embodiments above) of the invention in order to (e.g. providing information for) allow entering precise character(s) of a word during the data entry correction of the invention). These matters have been described in detail in corresponding application. For example, in addition to or instead of the second keypad of the invention for entering precise character(s), as described in different patent applications field by this inventor the any other means for the entry of precise character(s) may be used. Said means may include any type of keyboard (e.g. chording keyboard, half-QWERTY, Fitaly, shrunk keyboards (e.g. Fastap keypad, wherein for example, according to one method at least some of its numeric keys may duplicate the ambiguous (e.g. first) keypad of the invention as described, and its letter keys may be used for entering the precise characters), telephone-type keypad (e.g. using multi-tap), etc.) and the predefined interaction procedure provided with the keyboard/keypad for the entry of the precise single characters. Another input means may be user's speech as described by the inventor in different patent applications.

Obviously, instead of or in addition to integrating (e.g. the keys of) the system within a (mobile/fixed) device, an external keypad being (e.g. wirelessly or wired) connected to said device may be considered. For example, a portion (e.g. the software part) of the system may be installed within a laptop/desktop computer and a keypad having two (e.g. predefined) sets of keys connected to the said computer may be used from far with the system for entering that/data through the system to said computer. This permits to the user to interact comfortably from far with the computer.

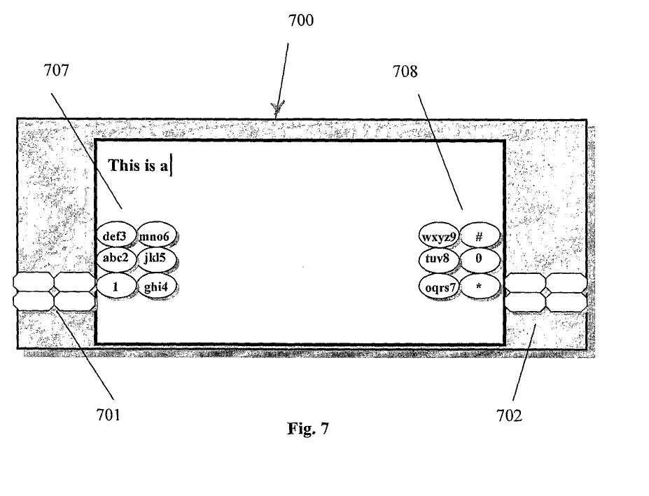

Also, as mentioned before, the first and/or the second keypad of the invention may have on screen keys. FIG. 7 shows the second keypad (e.g. a telephone-type keypad, in this example) having split on-screen keys 707, 708.

The (predictive) data entry system of the invention using a first and a second keypad as described above, permits the integration of the system within almost every mobile device (e.g. including the current mobile phone form factor) even with low power processor and limited memory. This version of the system and other versions of the system (e.g. (e.g. wherein the use of the first keypad of the invention that instead of or in addition to using the second keypad as described in this patent application, can be combined with the use of other means such a full-sized keyboard, and/or user's speech, etc. for entering precise characters) as described in detail in different previous patent applications field previously by this inventor), provide a complete solution to the fundamental problem of the (mobile) industry of how to enter text easily and quickly in the mobile environment by duplicating the functionalities of a full-sized computer keyboard. It must also be noted that as described in the previous patent applications field by this inventor, the speech provided by the user may be detected by the system based on for example, the user's voice of the user's lip (e.g. and eventually, also facial) movements.

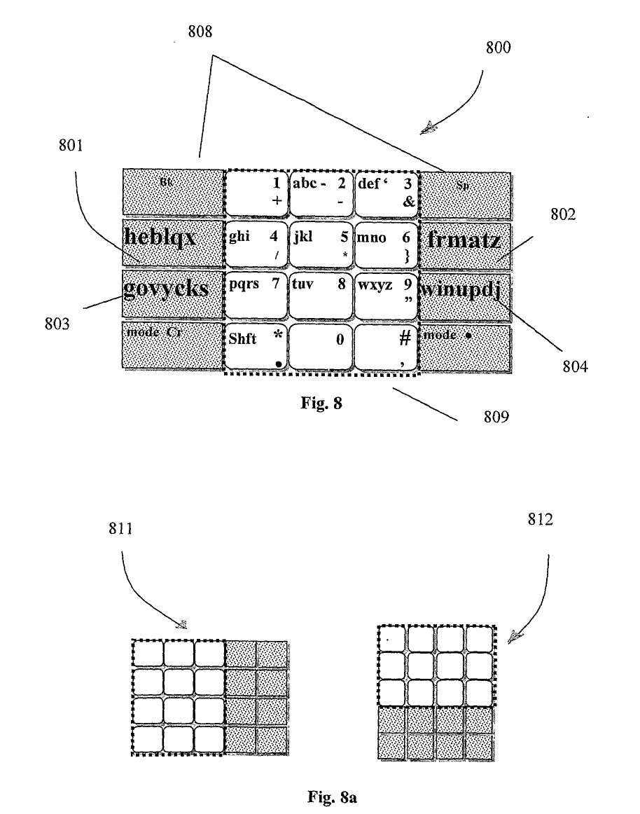

The data entry system of the invention using a first and a second set of keys (e.g. each set having ambiguous keys as described in this patent application) has great advantages. For example, the system may be integrated within any existing device such as mobile phones, or may be used as an external data entry unit of any device such as PCs, etc. For example, as shown in FIG. 8, a portion (e.g. the software part, not shown) of the system may be installed within a laptop/desktop computer and a (e.g. an external) keypad 800 having two (e.g. predefined) sets of keys 808, 809 connected to the computer may be used remotely with the system for entering data to said computer. The keys may be hard-wired to the computer, for example using a USB interface, or wirelessly, for example using the Bluetooth protocol. This permits the user to interact comfortably with the computer. For example the keys of a(n existing) numeric type keypad may be divided in a predefined manner into two sets of keys 808, 809 such that each set defining/duplicating one of said sets of keys, and working with the system. FIG. 8a shows two other types of divisions of said keys into two sets of keys on each of the keypad 811, 812 such that the darker keys define the first set of keys, and the lighter keys define the second set of keys.

It will be understood that the external keypad/data entry unit described above may be connected to the corresponding device such as a PC, TV, etc., by wires or wirelessly. Said external data entry unit may include any of other features such as a mouse (e.g. can be placed in the back to the unit), a microphone (e.g., if the system also uses speech recognition system), etc. It may also have its own display unit for displaying the data/text entered by the user, so that the user can see the data/text as it is entered (e.g. and is transmitted from the corresponding device) so as to permit the user to interact with the corresponding device from afar. The example of such data entry unit is described in detail in previous patent applications filed by this inventor. The text displayed on the screen of the data entry unit preferably may be displayed (simultaneously) on the screen of the corresponding device. The external data entry unit may also have its own other features such as its own processor and memory such that the software portion of the system also being integrated within said data entry unit, so that to permit the user to enter data/text independently from any other device, and (e.g. later) preferably connect said external data entry unit to a corresponding device to transfer said inputted data/text into said device.

The arrangement/distribution of letters on a few keys of the first and second set of keys (keypads) may vary considerably, as long as they are conformed to the letter distribution principles substantially as described herein; for example, any ambiguous key of the first keypad and any ambiguous key of the second keypad have at most one common character/letter. Another type of distribution of the letters of the English language on four keys 801-804 of the first keypad 808 is shown in FIG. 8 as an example.

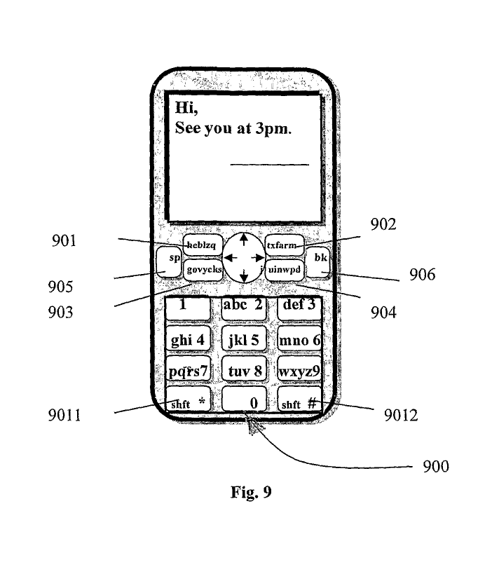

The first and second keypad may use at least one common key. For example, as shown in FIG. 9, the first keypad having the keys 901-906 can use the key 9011 and/or 9012 of the second keypad 900 as “Shift/mode” key of the first keypad. Said shift key(s) may also be used with the second keypad. For example when a user presses (and holds) said shift key and presses a key of the first keypad the corresponding symbol of the first keypad may be entered and when a user presses (and holds) said shift key and presses a key of the second keypad the corresponding symbol of the second keypad may be entered/related-to.

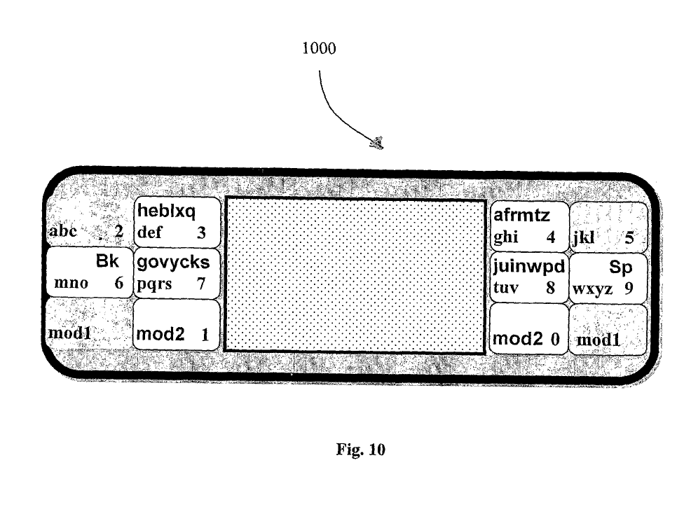

As mentioned before, instead of two different keypads the system may use two different types of interaction (e.g., short/long, shifted and non-shifted) with one keypad to duplicate two keypads. This was described earlier and shown earlier in FIG. 5. FIG. 10 shows said keypad 1000 with a type of arrangement/assignment of symbols onto each of said keypads. In this example, the eight lighter keys define the first keypad, and the whole twelve keys define the second keypad. There are two types of mode keys as example. The system may by default be in the first keypad mode. Meaning that pressing the lighter keys, by default may correspond to the first keypad. Also for example, pressing the mod1 key may enter the system into the second keypad mode. In this case pressing any of the twelve keys may correspond to the second keypad. Another pressing action on the mod1 key may switch the system back to the first keypad mode. Also for example, pressing and holding the mod1 key and pressing any of the twelve keys may correspond that key (pressing action) to pressing a key of the second keypad. Also for example, pressing the mod2 key may duplicate a mode key of the second keypad, or in a predefined manner so that it may be used as an additional mode key corresponding to the second keypad, etc. It is understood that the examples of the mode keys and the use of them here are shown only for demonstration purpose. Other type of means for switching between the two keypads may be considered by people skilled in the art.

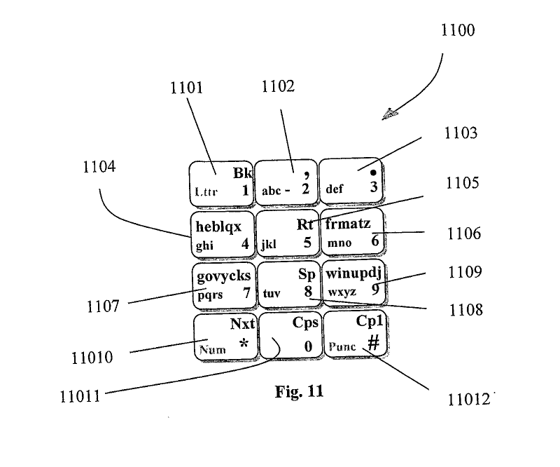

Another example of using two different types of interaction with (the keys of) one keypad 1100 (e.g. a telephone-type keypad) to duplicate two (e.g., ambiguous) keypads of the invention as described in this patent application (e.g. wherein a first predefined interaction with a key of the keypad represents/duplicates pressing a key of the first keypad of the invention, and a second type of interaction (e.g. double-pressing action with said key/long pressing with said key/press (e.g. and-holding) a first (mode) key and pressing said key, etc.) represents/duplicates interacting with a key of a second keypad of the invention, wherein characters/letters assigned said first type of interaction with said key and the characters/letters assigned said second type of interaction with said key have at most one common character) is shown in FIG. 11. According to this example, a first type of interaction such as a single-pressing action on the keys of said keypad may correspond-to/duplicate interacting with the first keypad of the invention that includes (e.g. in this example, four) ambiguous keys 1104, 1106, 1107, 1109. The corresponding distributed/assigned letters to said interaction with said keys are shown on the upper side of said keys, respectively. Also other symbols/functions assigned to said interaction (e.g. single-pressing actions) with said keypad are shown on the upper side of the corresponding keys (example: Backspace “Bk” function on key 1101, Return “Rt” function on the key 1105, Space “Sp” function/character on the key 1108, etc.).

In this example, another type of interaction with the keys of the keypad 1100 may be predefined to correspond to/duplicate interacting with (at least the letter) keys of a telephone-type keypad. For this purpose, in this example, several mode keys have been provided, example: “lttr” on the key 1101, “num” on the key 11010, and “punc” on the key “11012”. For example, pressing (e.g. and holding) the key 1101 may enter the system into the second keypad mode. In this case, for example, providing a single-pressing action on any of the keys 1102-1109 may correspond to the ambiguous letters shown on the lower side of said keys (e.g. letters a-z being distributed in the standard telephone-type manner on said key), and therefore this interaction may be used during the correction procedures of the invention as described earlier in this patent application. Accordingly, for example, pressing (e.g. and holding) the key 11010 may enter the system into the “number” mode of the second keypad mode. In this case, for example, providing a single-pressing action on any of the keys 11011, 1101-1109, may correspond to the digits 0-9 respectively. Also accordingly, for example, pressing (e.g. and holding) the key 11012 may enter the system into the “punc” mode of the second keypad mode. In this case, for example, providing a single-pressing action on of the keys of the keypad may correspond to a predefined punctuation mark/command assigned to this type of interaction on the corresponding key, said symbols are not shown on the keypad 1100). The example just shown may permit the data entry system of the invention using one set of keys with different types of interaction to be implemented within a telephone-type keypad.

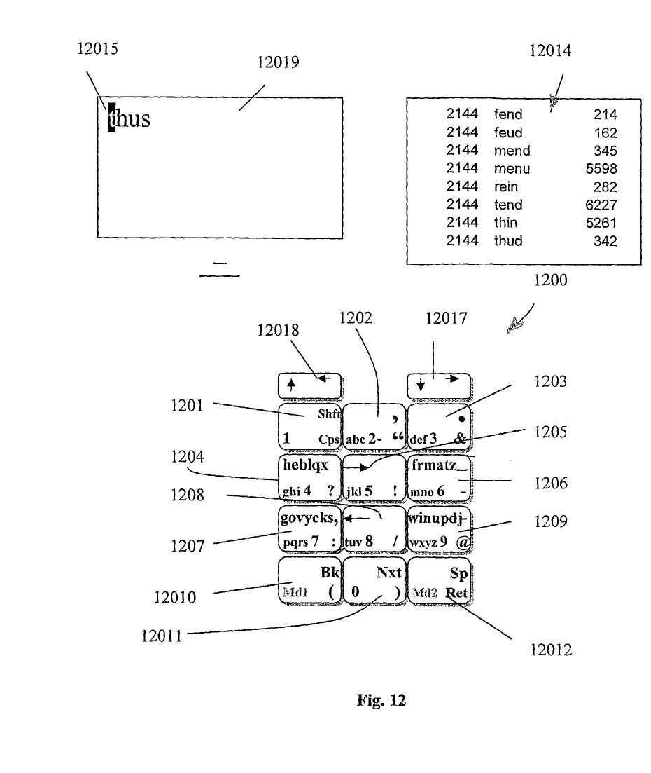

According to another example, FIG. 12 shows another telephone-type keypad 1200 using a mode key 12010 to switch between duplicating the first keypad (e.g. for providing (at least) the key pressing actions corresponding to the (ambiguous) characters of a desired word (e.g. the first input information)) and duplicating the second keypad (e.g. for providing the key pressing actions corresponding to the correction procedure of the invention for helping to enter (at least) precise characters (e.g. of said word)) of the data entry system of the invention through a single keypad (e.g. based on principles described in FIG. 11). According to one method, if the mode key 12010 is not being pressed, by default, the system may be in the “first keypad” mode. This means that for example by providing a first predefined of interaction such as (e.g. single) pressing (e.g. no chording action) any of the (e.g. four letter) keys 1204, 1206, 1207, 1209, may correspond to the (four) ambiguous keys of the first keypad of the invention. Corresponding characters/letters are shown on the upper side of said (four) keys. According to a first example and based on the principles of the word predictive data entry system of the invention as described in different patent applications filed by this inventor, by considering an exemplary portion 12014 of the dictionary database of words of the system, by providing single-pressing (consecutively) the keys 1206, 1204, 1209, 1209 may provide the word “tend” corresponding to said pressing key actions (e.g. first input information) and having the highest priority. If this is not the desired word, as an example, any of the following correction examples (among many other correction procedures of the system as described before) may be considered:
According to one method, as an example, in order to enter the word “rein”, at this time, the user may press (and hold) the mode key 12010 that may be predefined to enter the system into the “second-keypad” mode meaning that (now) pressing any of the (e.g. at least the letter keys of the telephone-type keypad) keys of the keypad (e.g. chording action) may correspond to the letters/characters assigned to the second keypad. In this example said characters are printed on the lower-left side of the keys of the keypad (e.g. in this example, standard distribution of letters on the telephone-type keypad). In this example, at this time, the user may press the key 1207 corresponding to the letter “r” (of the second keypad) (e.g. which is the first character of the word “rein”), and the system relates said pressing action to the letters “pqrs”. The only common character/letter between the group of characters “frmatz_” relating to the first key (1206) pressing action of the first input information (provided by single pressing the corresponding key without pressing (and-holding) another (e.g. mode) key (e.g. no chording), and the group of characters “pqrs” corresponding to providing the second type of interaction with the key 1207 (e.g. single pressing the key 1207 corresponding to the first character of the word and pressing (and-holding) a mode key 12010) is the letter “r”. The system may propose the word “rein” corresponding to the combined first and second (e.g. the correction) input information.
According to one example, if the word “thin” is the desired word, after the word “tend” is being proposed by the system (e.g. based on the first input information), the user may press (and hold) the key 12010 (e.g. causing the system to enter into the “second keypad” mode) and (e.g. single) press the key 1208 (e.g. said pressing actions on mode key and on the key 1208 corresponds to the letters “tuv”). The only common character/letter between the first key pressing action, provided through the first type of interaction with the key 1206, (e.g. corresponds to characters “frmatz_”) and the second type of interaction (chording interaction) with the key 1208 (e.g. corresponds to characters “tuv”) is the letter “t”. The word “tend” is the word that matches to the combined first and second input information and has the highest priority. Said word has already been proposed to the user. According to one method, the system may propose the word “thin” that corresponds to said (combined) first and second information and has the next highest priority after the word “tend”.
According to one method, after the word “tend” is being proposed by the system and the user enters a precise character through the correction procedure of the invention as described above, if the system does not find a corresponding word in the dictionary database of the system, it replaces/corrects only that character in the corresponding location within the proposed word. For example, if the user presses the mode key 12010 and presses the key 1209, the system relates said pressing action to the letters “wxyz”. The only common character between the group of letters/characters “frmatz_”) and the group of letters/characters “wxyz” is the letter “z”. In this example, there is no word that corresponds to said first and second input information. The system may print/propose the chain of characters/word “zend”.
According to one example/method, after a word is being proposed by the system through the input information provided by the user, the user may press a “Nxt” key 12011 and the system may propose the word corresponding said input information that was provided by the user and that said word has the next highest priority. For example,
   for example, after the word “tend” is being proposed by the system based on the first input information, if the user presses the key 12011, the system proposes the word “menu”.
   also for example, after the word “thin” is proposed by the system based on the first input information and the second, i.e. additional input information, if the user presses the key 12011, the system proposes the word “thud”.

Obviously, instead of a mode key, any other means for switching between the two keypad modes may be considered. Also obviously, instead of a chording action, other second predefined interactions such as pressing the mode key 12010 and releasing it may be used to enter the system into the second keypad mode. At this time pressing any key of the keypad may be related to pressing a key of the second keypad. Obviously, accordingly, pressing again said mode key 12010 may bring back the system to the first keypad mode. It is understood that other different types of interactions may be considered for entering the system into the first or second keypad mode. Although the data entry system as described uses two keypads, obviously additional keypads may be considers. Accordingly, additional types of interactions may be considered to duplicate said additional keypads.

According to some embodiments, the data entry system of the invention may permit the user to select any (ambiguous or precise) letter/character of a proposed word and replace it by a precise character through the correction procedure described hereinabove. The system then (if designed to) may consider said additional/second input information and may combine it with the first (e.g. previous) input information provided by the user for entering the desired word so that eventually to propose another word of the dictionary (e.g. described before). As shown in FIG. 12, for ease of follow up/interaction, the selected character (in this example 12015) may be highlighted on the screen by the system. Accordingly, the system may include a “character selecting” means that may permit the user to navigate over the characters of the proposed word to select one of them so that the user changes it (e.g. through the second keypad) and, optionally/preferably, as described, causing the system to propose another word if there is any appropriate candidate word in the dictionary database. According to one method, when the user enters a word, by default, the system may automatically select and highlight the first ambiguous character (e.g. 12015) of the proposed word. According to one method, for example, if the user proceeds to the correction procedure and presses the corresponding key of the second keypad, the system relates the pressing action of the correction procedure to the selected character. after the user enters a precise character of the word, the next ambiguous character of the word may automatically be selected (and highlighted) by the system.

In addition to the standard four directions of navigation means (e.g. the four PC keyboard arrows) navigating a cursor within a text (e.g. in FIG. 12 they are assigned to different types of interactions with two keys 12018, 12017), FIG. 12 shows a left and right selection keys 1208, 1205 for navigating and selecting a character within the (proposed) word (e.g. or any word of the text) as described above. It must be noted that the user may (even) select a precise character of the (proposed) word and replace it by another precise character (e.g. the system does not-consider/deletes the input information corresponding to said previous precise character provided through the corresponding previous correction procedure and replace it by the new input information provided through the current correction procedure for entering said another precise character.

Obviously, providing the first predefined interaction with the other, perhaps unambiguous keys (e.g. other than said four keys) of the keypad may correspond to entering some of the other (preferably commonly used) symbols such as “Space” character, “BkSp” function, “Return” function, special characters and punctuation marks such as “.”, “,”, etc., some of which are shown in FIG. 12 (in this example some of them printed on the upper-right side of the keys).

In the example of FIG. 12, another mode key 12012 may be used for entering additional special characters assigned to different keys of the keypad (in this example, some them are printed on the lower-right side of the keys. For example, pressing (and holding) the key 12012 and pressing the key 1209 may correspond to the character “@”.

As mentioned before, it must be noted that the words of the dictionary may also include any special character such as apostrophe (e.g. “it's”), or any digit, etc. For this purpose, generally a set of combined characters (e.g. including letters, numbers, special characters, etc.) of a language may be distributed on the keys of each of the first and the second keypad (e.g. or to each of the two different predefined interactions with the keys of one keypad) such that characters assigned to pressing a (e.g. any) key of the first keypad and characters assigned to pressing a (e.g. any) key of the second keypad (e.g. or characters assigned to providing a first predefined interaction with any key of a keypad and characters assigned to providing a second predefined interaction with any key of the same keypad) have one common character, (this matter has already been described before).

It will be noted that according to some embodiments, pressing (e.g. and releasing) a mode key without combining with pressing another key may be used for entering a predefined character assigned to any of said mode keys.

It will be noted that the features such as keypads, key arrangements, number of keys, assignment of a set of characters of a language to each of a first and second set of keys (e.g. or to each of a second and a second type of interactions with one set of keys), type of keys, type of interactions, etc., as described and shown in this patent application are shown as examples to describe different embodiments of the invention. Obviously, other type of such features can be considered by people skilled in the art.

It will be noted that as described hereinabove, the correction procedure (e.g. pressing action(s) on the keys of the second keypad for correcting/changing a proposed word) may preferably be possible if the cursor is located at a predefined position relating to said word such as at the end of said word/chain of characters (e.g. preferably, in a predefined manner, after the last character of the word). This permits to correct a (e.g. non-desired) word either immediately after the system proposes said (non-desired) word or later (e.g. leaving said non-desired word as is and continuing to enter more words, or after reloading the corresponding document, etc.) by for example repositioning the cursor at the end of said (non-desired) word and (preferably) correcting it through the second keypad as described in this patent application.

According to one method, the user may place the cursor after any character of the proposed word to change said character by pressing the corresponding key of the second keypad. According to another method, in the middle of the entry of a (e.g. a non-completed) word, the user may proceed to the correction procedure to correct the currently proposed word/chain-of-characters such that when the user continues to enter the remaining characters of the desired word, preferably, that (e.g. the beginning) portion of the word does not change on the screen.

It must be noted that although in this patent application “key” and “(predefined) type of interaction with key” has been used to demonstrate different embodiments and methods as described, obviously, any (predefined) input means (e.g. providing a first and a second group of input signals) and any (predefined) type of interaction provided through said input means to provide a (predefined/different) input signal may be used for the same purpose. For example, instead of distributively assigning the set of letters of a language to the keys of a first keypad, the letters may be assigned to a first predefined type of interaction, such as a single-pressing action on the keys, for example, using the keys of said keypad. Also, instead of distributively assigning another set of letters of the language to the keys of a second keypad, the letters may be assigned to a second predefined type of interaction, such as a double-pressing action, pressing and holding a mode or function key and single-pressing, etc. on/with the keys of the first keypad. Obviously, based on the principles of the data entry systems of the invention as described above, the distribution/assignment of the letters to said first and second type of interaction with said keys may be such that letters assigned to the first type of interaction with any on the keys of said keypad and letters assigned to the second type of interaction with said key of said keypad have at most one common character.

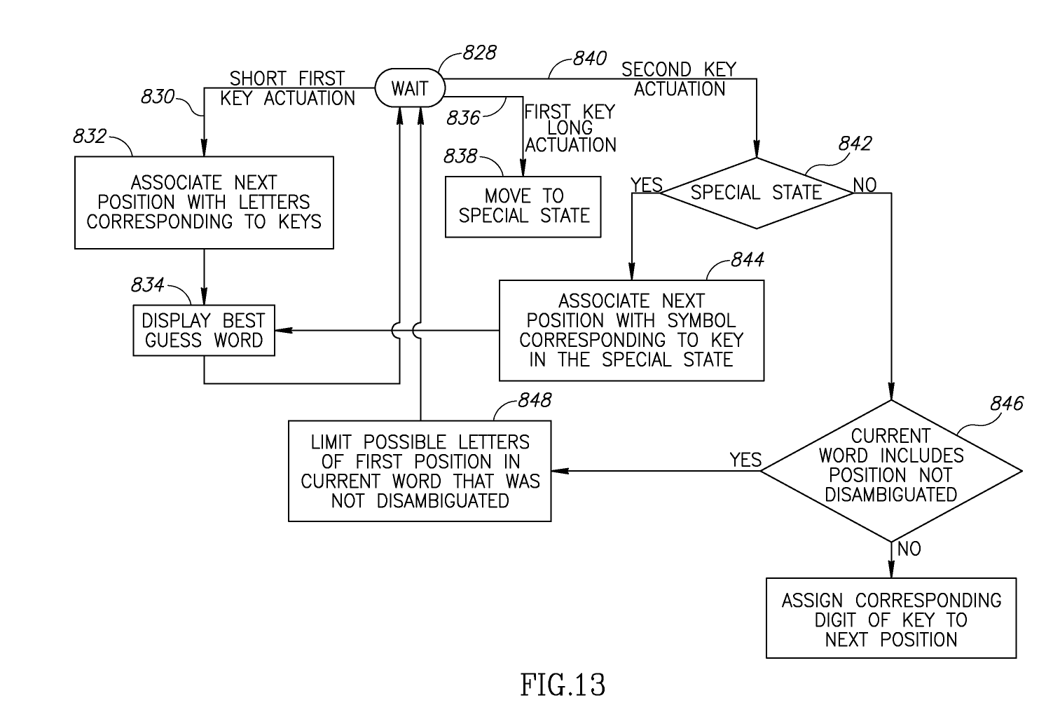

FIG. 13 is a flowchart of acts of a data entry system, in accordance with an exemplary embodiment of the invention. System 828 remains in a wait state (828) in which it waits for key actuations. When (830) a key of the first set is actuated for a short period, the next cursor position is associated (832) with all the letters corresponding to the actuated first set key. The processor of the data entry system then optionally selects and displays (834) a best match word for the current input. Optionally, the displayed word is selected by selecting the most popular word that matches the available information on the current word.

When (836) a key of the first set is actuated for a period longer than a predetermined length, the processor moves (838) to a special state in which the second keys are given special character interpretations. Optionally, the predetermined length is of a duration substantially longer than normally used by users entering data, such that only purposeful long actuation of the key will be interpreted as a state change. In some embodiments of the invention, the processor remains in the special state, until the key is released. Alternatively, the processor remains in the special state until a different state key is actuated. Optionally, in this alternative, one of the first keys is associated with moving into the regular state.

Special states may be provided for digits, function keys, foreign alphabets, mathematical symbols (e.g., >, <, =, +) and/or other groups of symbols provided on standard keyboards and/or provided by known in the art word processing software.

When a second key is actuated (840), the processor optionally determines whether (842) it is currently in a special state. If (842) the processor is in a special state, the next word position is associated (844) with the symbol corresponding to the actuated key in the special state. In some embodiments of the invention, the processor then reselects the word to be displayed (834). It is noted, however, that same states may correspond to symbols not included in words of the dictionary of the processor and therefore their combination to the current word will not result in a known dictionary word. In such cases, the display may be updated only for the position currently updated with the symbol. Alternatively or additionally, the fact that the position of the recently added symbol does not include a letter is used in selecting an updated best guess word.

If (842) when the second key is actuated (840) the processor is not in a special state, the processor optionally determines whether (846) the current word includes positions that ambiguously correspond to a plurality of letters and were not disambiguated. If (846) there are such non-disambiguated positions in the current word, the letters corresponding to the second key are used to limit (848) the first position in the word that was not yet disambiguated. In some embodiments of the invention, each pair of first and second keys have in common only a single letter, such that the disambiguation results in a specific letter. Alternatively, pairs of first and second keys may have a plurality of letters in common, for example up to two or three letters in common. This option allows reducing the number of letters in the first and/or second set of keys.

If (846) there are no non-disambiguated positions in the current word, the next position in the current word is assigned (850) a digit corresponding to the pressed second key. Alternatively, any other set of symbols, for example any of those used in one of the special states, may be associated with the second keys for cases in which there are no non-disambiguated positions in the current word. Further alternatively, when there are no non-disambiguated positions in the current word, the next cursor position is associated with all the letters corresponding to the actuated second-set key. This alternative allows the user to choose dynamically whether to begin writing with the first keys and correct ambiguities with the second keys or to write with the second keys in fix ambiguities with the first keys.

It is noted that, although according the preferred principle/embodiment of the invention a full set of the letters of a language are distributively assigned to few (e.g. four) keys of a first keypad and another same full set of the letters of the same language are distributively assigned to few keys of a second keypad (e.g. to eight keys of a telephone-type) such that any key of said letter keys of said first keypad and any key of said letter keys of said second keypad have at most one common letter, however, minor modifications/variations may be considered/provided to this principle by people skilled in the art. For example, one (or more) of the (e.g. ambiguous) keys of the first keypad and one (e.g. ambiguous) key of the second keypad (e.g. as just mentioned above) (for some reason) may have more than one common character (although this may augment the ambiguity and slow down the recognition capacity of the system requiring more user's input information).

The input system of the embodiments of the present invention may be used with substantially any electronic and/or computerized device, such as cellular phones, GPS devices, remote controls, hand held devices, television sets and music players. This input system is particularly useful for small sized and/or portable devices on which it is inconvenient to place an entire keyboard. In addition, these input devices may be used on appliances not primarily intended for data input, such as washing machines, refrigerators and the like, which conventionally do not include large keyboards.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. For example, although the keys are being named and shown as the input means in this patent application, obviously, other input means such as user's fingers, sensors used with a glove, and finger caps may be used. Furthermore, any type of input signals such as any predefined interactions, such as glide actions, different duration actions and/or different pressure levels may be used for the first set and/or second set of keys, including any of those described in PCT publications WO01/131788, titled “Integrated Keypad System”, WO03/007288 titled “Features to Enhance Data Entry Through a Small Data Entry Unit”, WO04/095414 titled “System to Enhance Data Entry in Mobile and fixed Environment”, WO05/122401 titled “System to Enhance Data Entry in Mobile and fixed Environment”, WO07/114833 titled “Data Entry System”, and PCT application IB2007/004481, the disclosures of all of which are incorporated herein by reference in their entirety. In addition, any of the features described in these patent documents may be added to any of the above described embodiments.

It is noted that in many paragraphs a first and a second keypad have been defined, for use with the data entry system of the invention. However, it will be appreciated that the system may alternatively use a first and a second group of (different) input signals for the same purpose.

1-40. (canceled)

41. A computerized device comprising:
a first input interface adapted to identify a plurality of different first user input signals;
a second input interface adapted to identify a plurality of second user input signals, and
a processor configured to ambiguously correspond each of at least one of the first input signals with a first plurality of symbols, and to ambiguously correspond actuation of each of at least one of the second input signals with a second plurality of symbols,
wherein the processor associates each of the second plurality of symbols with one of the first input signals, in a manner that the second plurality of symbols correspond to a plurality of the first input signals.

42. A device according to claim 41, wherein the processor corresponds each of the second input signals with a plurality of symbols.

43. A device according to claim 41, wherein the processor corresponds the first input signals with symbols, such that taken together the first input signals are associated with all the letters of an alphabet of a natural language.

44. A device according to claim 43, wherein the processor corresponds four different first input signals with all the letters of an alphabet of a natural language.

45. A device according to claim 44, wherein the first input interface comprises four keys for receiving the four different input signals.

46. A device according to claim 45, wherein the first input interface comprises additional keys for receiving a space character signal and a back space function signal.

47. A device according to claim 43, wherein the processor corresponds the second input signals with symbols, such that taken together the second input signals are associated with all the letters of the alphabet.

48. A device according to claim 47, wherein the processor corresponds eight second input signals with all the letters of the alphabet, wherein each of the eight input signals is provided through a different key of the second input interface.

49. A device according to claim 41, wherein the processor is configured to guess a word intended by a user based on a sequence of first input signals.

50. A device according to claim 49, wherein the processor is configured to update its word guess responsive to one or more of the second input signals.

51. A device according to claim 41, wherein the processor is configured to apply first input signals and second input signals received from a same cursor location, to different character positions in a current word, in at least some cases.

52. A device according to claim 41, wherein the processor is configured to associate a second input signal with a character not corresponding to any of the first input signals, when the second input signal is provided not during insertion of a word using the first input signal.

53. A device according to claim 41, wherein the first input interface is selected from the group comprising: a physical keypad and a touch screen and a virtual keypad.

54. A device according to claim 41, wherein the first input interface comprises a plurality of first keys and the second input interface comprises a plurality of second keys and wherein the processor is configured to relate to at least one of the first keys as a state selection key of one or more the second keys, when the first key is pressed for longer than a predetermined duration.

55. A device according to claim 41, wherein the processor is configured to associate the first and second input signals with symbols in a manner such that each pair of first and second input signals has in common at most one symbol.

56. A device according to claim 41, wherein the first input interface supports no more than six different input signals, which are used for inserting symbols.,
